(19) United States
(12) Patent Application Publication
(10) Pub. No.: US 2010/0177027 A1
(43) Pub. Date: Jul. 15, 2010

(54) LIQUID CRYSTAL DEVICE AND METHOD OF DRIVING LIQUID CRYSTAL DEVICE

(76) Inventor: Hajime Ikeda, Kanagawa (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/601,991

(22) PCT Filed: May 22, 2008
(86) PCT No.: PCT/JP2008/059855

§ 371 Date: Nov. 25, 2009

(30) Foreign Application Priority Data
May 25, 2007 (JP) 2007-139579

(51) Int. Cl. G09G 3/36

(52) U.S. Cl. 345/92; 345/87

(57) ABSTRACT

A liquid crystal device comprising: at least a liquid crystal element having a pair of substrates with electrodes on the inner sides thereof and a liquid crystal material disposed between the substrates, and a charge supplier for supplying electric charge to the liquid crystal element. The alignment of the liquid crystal molecules in the liquid crystal element is controlled in response to a change in the electric charge quantity to be supplied between the pair of electrodes from the charge supplier. A liquid crystal device, whose display quality can be substantially maintained at a high optical response speed, and a driving method thereof can be provided.

### TECHNICAL FIELD

The present invention relates to a liquid crystal device (for example, a liquid crystal device using a fast response PSS-LCD (i.e., polarization shielding type smectic liquid crystal display) technique and a method of driving a liquid crystal device. In more detail, the present invention relates to a PSS-LCD liquid crystal device, whose display quality can be substantially maintained at an elevated optical response speed, and a method of driving a PSS-LCD liquid crystal device. With respect to the details of the “PSS-LCD” technique which has been developed by our research group, e.g., Japanese Unexamined Patent Publication (JP-A) No. 2006-515935 may be referred to, as desired.

### BACKGROUND ART

Generally, a liquid crystal device (display device) comprises a pair of (two) glass substrates, each of which is provided, on inner sides thereof (i.e., on the sides of the glass substrates, between which a liquid crystal material is to be disposed), with a transparent electrode, wherein the glass substrates are spaced at a gap of a few micro meters, and a liquid crystal material is filled in the gap. When a voltage is applied between the pair of electrodes, the alignment of the liquid crystal is changed to thereby control the state of light passing through the liquid crystal material layer, so that a predetermined pattern is displayed depending on the difference in the quantity of light passing through the liquid crystal material layer. That is, in a liquid crystal device in the prior art, the alignment of the liquid crystal molecules constituting the liquid crystal material is controlled by controlling the voltage to be applied between the above-mentioned pair of electrodes.

However, the conventional liquid crystal device has a drawback that the display quality is inevitably deteriorated when the optical response speed is increased.

Generally, in most of the liquid crystal display products marketed at present, images are displayed by an active matrix driving using a TFT element. In the TFT-type liquid crystal element, one-to-one correspondence is established between TFTs and additional capacitors to control each pixel element of the liquid crystal panel, to thereby enhance the start-up speed and provide thereto a memory function. Thus, the poor response of a TN (twisted nematic) type liquid crystal is has been solved, and further, the “coloring” due to the interference of transmitted light is made less observable.

In the matrix driving system, longitudinal and transverse electrodes are disposed for the pixel elements which are arranged in a matrix. When a voltage is applied to selected longitudinal and transverse electrodes, the voltage will drive a corresponding pixel element, which is energized by selecting both of the longitudinal and transverse electrodes at the pixel element. This driving system can dramatically reduce the number of wires, because the driving system only requires power wires, the number of which is equal to the sum of the numbers of rows and the numbers of columns of the pixel matrix along which the pixel elements are arranged. In an active matrix driving system, a TFT and an additional capacitor are connected to each of the pixel element in a liquid crystal cell, so that each pixel element can be controlled therethrough. With this structure, charges are accumulated in the additional capacitors and, due to the memory function, the substantial drive voltage application time can be extremely shortened in combination with a TFT fast switching circuit.

In other words, in the above-mentioned active matrix driving system, in general, the gray scale of an image is displayed by adjusting the voltage to be applied to each pixel element constituting an image to be displayed, that is, the alignment of liquid crystal molecules is controlled by the voltage to be applied to the pixel element. An active matrix driving system using TFT elements has a mechanism that the electric current is supplied from the source side to the drain side of the TFT, by applying a high voltage to the gate, to thereby make the source side potential difference equal to the drain side potential difference. Then, the source side and drain side are disconnected at a high resistance by removing the high voltage applied to the gate (in this case, the duration time in which the high voltage is applied to the gate is referred to as “gate-on time”), and accordingly, the drain voltage is maintained in this mechanism. Incidentally, Japanese Unexamined Patent Publication No. 6-160809 describes an area gradation technique, wherein the binary display area of a ferroelectric liquid crystal is controlled in accordance with the electric charge quantity.

In recent years, in combination with the progress in technique aiming at a so-called “ubiquitous society”, there are sophisticated various needs for the display techniques in general, such as high-speed response and high display quality.

To meet such needs, a technique has been increasingly demanded to substantially hinder the display quality deterioration at a high optical response speed, in a variety of application fields (for example, a large display television using liquid crystal devices).

However, when an attempt was made to realize faster response of a liquid crystal device, in line with the above-mentioned needs for fast response speed, etc., the display quality, which is another important need in this field, has inevitably been deteriorated in some cases.

### [Patent Document 1] JP-A No. 2006-515935

### [Patent Document 2] JP-A No. 6-160809

### DISCLOSE OF THE INVENTION

An object of the present invention is to provide a liquid crystal device which is capable of solving the problems encountered in the above-mentioned conventional techniques; and a method of driving such a liquid crystal device.

Another object according to the present invention is to provide a liquid crystal device, with which the display quality can be substantially maintained, even when the optical response speed thereof is increased; and a method of driving such a liquid crystal device.

As a result of the present inventor, it has unexpectedly discovered that the alignment of liquid crystal molecules is quite effectively controlled to achieve the above-mentioned object by a method of controlling the electric charge to be supplied to an electrode, but not by controlling the intensity of electric field to be applied to the liquid crystal material, as the conventional method.

The liquid crystal device according to the present invention is based the above discovery. More specifically, the liquid crystal device according to the present invention comprises: a liquid crystal element; the liquid crystal element comprising, at least, a pair of substrates, each of which has an electrode on the inner side thereof (on which a liquid crystal material is to be disposed), and a liquid crystal material disposed between the pair of substrates; and a charge supplier for supplying electric charge to the liquid crystal element; wherein the alignment of liquid crystal molecules in the liquid crystal element can be controlled on the basis of a change in the electric charge quantity to be supplied between the pair of electrodes from the charge supplier.

The present invention also provides a method of driving a liquid crystal device; the liquid crystal device comprising: a liquid crystal element comprising, at least, a pair of substrates, each of which has an electrode on the inner side thereof, and a liquid crystal material disposed between the pair of substrates; and a charge supplier for supplying electric charge to the liquid crystal element; wherein, the alignment of liquid crystal molecules in the liquid crystal element is controlled by changing the electric charge quantity to be supplied between the pair of electrodes from the charge supplier.

The mechanism of operation of the liquid crystal device according to the present invention having the above-mentioned structure will be described hereinbelow on the basis of the present inventor' presumption, in comparison with the mechanism of operation of other liquid crystal devices.

In the above-mentioned active matrix driving system, as long as the source side potential difference is equal to the drain side potential difference within the above-mentioned “gate-on” time, a change in the drain side potential difference during the time has been neglected in the prior art.

According to the inventor's knowledge and investigation, it is presumed that the reason why the change in the drain side potential difference has not been noted, resides in the fact that the change during the gate-on time cannot substantially appear as an optical response, because the response speed of the conventional liquid crystal in use is extremely low as compared to the gate-on time.

However, as described above, with the increase in the optical response speed of the liquid crystal devices in recent years, the deterioration in the display quality has actually appeared. According to the inventor' knowledge and investigation, the reason why the deterioration in the display quality has actually appeared may presumably be considered in the following manner.

Usually, an optical response change within the gate-on time can be observed visually. However, because the display holding time is overwhelmingly longer than the gate-on time, it is presumed that the optical response change, if any, during the gate-on time is considered negligible in the liquid crystal displays at present. This is because the optical response speed of the liquid crystal display on the present market is not so high that the optical response change is observable during the gate-on time. However, with respect to the above-mentioned PSS-LCD technique which has been developed by the present inventor which can achieve a remarkably fast optical response, it has been found that, the optical response change during the gate-on time (which has not been noted in the conventional liquid crystal devices) appears as an actual difference in the optical response during the gate-on time. According to the inventor's study, it has been found that, as specific examples, such a difference which can be clearly recognized as a signal degradation due to an increase in wiring resistance and wiring parasitic capacitance along with an increase in the size of the display and high definition. Further, according to the inventor's study, it has also been found that, the increase in signal transmission due to an increase in the image resolution, etc., invites a relative signal deterioration, to thereby result in the occurrence of an impediment such as brightness shading. Such a signal deterioration causes the signal waveform to be different from the intended shape of the waveform, and it has also been found that a liquid crystal capable of fast optical response has a tendency to show an optical response in accordance with such a (varied) signal. Therefore, in an extremely fast optical response liquid crystal device, the optical response can be different from an intended optical response so that the display quality may be reduced.

It is presumed that, because of the increase in the optical response speed, the response time becomes quite close to the order of the gate-on time, so that the influence caused by the change in the potential difference, i.e., the change in the intensity of the electric field to be applied to the PSS-LC during the gate-on time can be clearly recognized (for example, the PSS-LCD is several ten times faster than that of the conventional liquid crystal and is quite close to the order of gate-on time).

The present invention can include, for example, the embodiments described below.

[1] A liquid crystal device, comprising:

a liquid crystal element; the liquid crystal element comprising, at least, a pair of substrates, each of which has an electrode on the inner side thereof (on which a liquid crystal material is to be disposed), and a liquid crystal material disposed between the pair of substrates; and

a charge supplier for supplying electric charge to the liquid crystal element;

wherein the alignment of liquid crystal molecules in the liquid crystal element can be controlled on the basis of a change in the electric charge quantity to be supplied between the pair of electrodes from the charge supplier.

[2] A liquid crystal device according to [1], wherein the liquid crystal element has an optical axis azimuth, which is rotatable in response to the intensity and/or direction of an electric field to be applied to the liquid crystal element at a level of 10 to 2 V/μm.

[3] A liquid crystal device according to [1] or [2], wherein the liquid crystal element is capable of providing a high-speed response at a level of 1 ms.

[4] A liquid crystal device according to any of [1] to [3], wherein the liquid crystal element comprises, at least, a pair of substrates and a liquid crystal material disposed between the pair of substrates, and

wherein the molecular initial alignment in the liquid crystal element is parallel or substantially parallel with the alignment treatment direction for the liquid crystal material, and the liquid crystal material shows substantially no spontaneous polarization perpendicular to the pair of substrates in the absence of an externally applied voltage.

[5] A liquid crystal device according to any of [1] to [4], wherein a change in the electric charge quantity to be supplied between the pair of electrodes is dependent on at least one parameter selected from the group of time-differential value of electric field intensity, cumulative quantity of light transmitted through the liquid crystal element, voltage corresponding to each pixel element, and the gate-on time.

[6] A liquid crystal device according to [5], wherein the voltage corresponding to each pixel element is a voltage of each TFT (thin film transistor) corresponding to each pixel element.

[7] A liquid crystal device according to any of [1] to [6], wherein the charge supplier comprises, at least:

a gate voltage supplier capable of changing gate voltage in association with source voltage, so as to provide a constant potential difference between the gate voltage and source voltage;

a source voltage supplier capable of applying the source voltage, in accordance with drain voltage, which is a potential difference due to the charge stored in the previous pixel element.

[8] A method of driving a liquid crystal device; the liquid crystal device comprising: a liquid crystal element comprising, at least, a pair of substrates, each of which has an electrode on the inner side thereof, and a liquid crystal material disposed between the pair of substrates; and a charge supplier for supplying electric charge to the liquid crystal element;

wherein, the alignment of liquid crystal molecules in the liquid crystal element is controlled by changing the electric charge quantity to be supplied between the pair of electrodes from the charge supplier.

[9] A driving method according to [8], wherein the electric charge quantity to be supplied to the liquid crystal element is controlled so as to control an increasing rate or decreasing rate, which is the time-differential value of the electric field intensity to be applied to the liquid crystal element.

[10] A driving method according to [8], wherein the time-differential value of the electric field intensity to be applied to the liquid crystal element is controlled so as to continuously control the cumulative quantity of light transmitted through the liquid crystal element, to thereby effect a gray scale display.

[11] A driving method according to [8], wherein the charge supplier includes TFTs, and the time-differential value of the electric field intensity is controlled by controlling the gate-on time and/or voltage for each TFT.

In general, analog gray scale cannot be displayed in a binary representation (for example, in the case of ferroelectric liquid crystal) using spontaneous polarization. Therefore, an idea of controlling the electric charge quantity to be supplied is necessary, in order to apply to a liquid crystal device capable of displaying analog gray scale. Further, it is obvious that a ferroelectric liquid crystal which cannot display the analog gray scale is not competitive in terms of the market needs for demanding high color-rendering property.

For example, JP-A No. 6-160809 discloses a dithering method of gray scale technique, wherein the binary representation area of the ferroelectric liquid crystal is controlled by the charge quantity. In this technique, when applied to a projector wherein pixel elements are extended and projected, the area gray scale portion in a pixel element is enlarged to the size which is distinguishable by the resolution of human eyes, and consequently only images having deteriorated quality are displayed.

Further, the spontaneous polarization of a ferroelectric liquid crystal is usually large, and therefore the charge quantity required for the gray scale display is extremely larger than that in the case of TN or PSS-LCD, and the power consumption becomes larger. In addition, because the inversion of the spontaneous polarization requires an electric charge quantity exceeding a certain threshold, the updating of pixel element representation requires a quantity of electric current exceeding a certain value. This is contrary to the market need for demanding low electric consumption. Further, in the case of a TFT, etc., which is not suitable for treating high current, the latitude (or degree of freedom) in the design of the TFT will more severely be restricted. As a result, it is difficult for the technique using the ferroelectric liquid crystal to attain a specification which meets the needs for cost, outer shape, etc.

### BRIEF DESCRIPTION OF DRAWINGS

FIG. 1 is a graph showing an example of the relationship between the electric charge quantity to be supplied and the quantity of transmitted light in PSS-LC.

FIG. 2 is a schematic view showing an example of the relationship between the electric charge quantity to be supplied and the electric field/potential difference.

FIG. 3 are graphs each showing an example of the current-voltage characteristics of a TFT for driving a liquid crystal device.

FIG. 4 is a schematic circuit view showing an example of the TFT structure for driving a liquid crystal device.

FIG. 5 is a graph schematically showing an example of the relationship between the source voltage and the drain voltage during gate-on.

FIG. 6 is a graph schematically showing an example of the relationship in the case of a constant gate-source voltage.

FIG. 7 is a graph schematically showing an example of the relationship between the drain voltage gradient control and the speed-up in the case of a constant drain-source voltage.

FIG. 8 is a graph schematically showing an example of the relationship between the optical response (1) and gate voltage in a case where the charge supply quantity is regulated by changing the gate voltage.

FIG. 9 is a graph schematically showing an example of the relationship between the optical response (2) and gate voltage in a case where the charge supply quantity is regulated by changing the gate voltage.

FIG. 10 is a graph schematically showing an example of the relationship between the optical response (3) and gate voltage in a case where the charge supply quantity is regulated by changing the gate voltage.

FIG. 11 is a graph schematically showing an example of the relationship between the optical response (4) and gate voltage in a case where the charge supply quantity is regulated by changing the gate voltage.

FIG. 12 is a graph schematically showing an example of the relationship between the conventionally controlled source voltage and the average gradient of the quantity of transmitted light.

FIG. 13 is a graph schematically showing an example of the relationship between the gate voltage and the average gradient of the transmitted light quantity when the electric charge quantity to be supplied is controlled by changing the gate voltage.

FIG. 14 is a graph schematically showing an example of the relationship between the gray scales obtained by conventional source voltage control and the gray scales obtained by the charge supply quantity control.

FIG. 15 is a schematic view showing an example of the structure for confirming the alignment control in response to the charge quantity.

FIG. 16 is a schematic view showing an example of the driving circuit structure for providing the time-differential value of the electric field intensity.

FIG. 17 is a block diagram showing an example of the driving circuit structure for controlling the voltage/gate-on time of each TFT.

FIG. 18 is a graph showing an example of the polarization switching current during the molecular orientation switching under the application of a triangular waveform voltage.

FIG. 19 is a graph showing an example of the polarization switching peak current in the case of conventional SSFLCD panel.

FIG. 20 is a view schematically showing c-director profile of PSS-V-FLCD.

FIG. 21 is a view schematically showing a rubbing angle of a laminate panel.

FIG. 22 is a schematic perspective view showing an example of the structure of preferred element for strictly measuring an optical axis azimuth.

FIG. 23 is a schematic view showing a perspective view showing an example of the structure of a measurement system which may be used when carrying out the source voltage control for controlling the electric charge quantity.

### BEST MODE FOR CARRYING OUT THE INVENTION

Hereinbelow, the present invention will be described in detail, with reference to the accompanying drawings as desired. In the following description, “%” and “part(s)” representing a quantitative proportion or ratio are those based mass, unless otherwise noted specifically.

### (Liquid Crystal Device)

The liquid crystal device according to the present invention comprises, at least, a liquid crystal element (such as high-speed operable liquid crystal element); and a charge supplier for supplying electric charge to the liquid crystal element, wherein the liquid crystal element comprises, at least, a pair of substrates and a liquid crystal material disposed between the pair of electrodes. In this liquid crystal device, the alignment of liquid crystal molecules in the liquid crystal element can be controlled in response to a change in the electric charge quantity to be supplied from the above-mentioned charge supplier to the above-mentioned liquid crystal material.

### (Alignment Control Based on Change in Electric Charge Quantity)

In the present invention, the alignment of liquid crystal molecules in a liquid crystal element is controlled in response to a change in the electric charge quantity to be supplied to the liquid crystal material from the charge supplier. The fact that the alignment control of liquid crystal molecules is not based on a change in the electric field intensity, but based on a change in the electric charge quantity to be supplied to the liquid crystal material can be confirmed by the method described below.

### <Method of Confirming Alignment Control Based on Electric Charge Quantity>

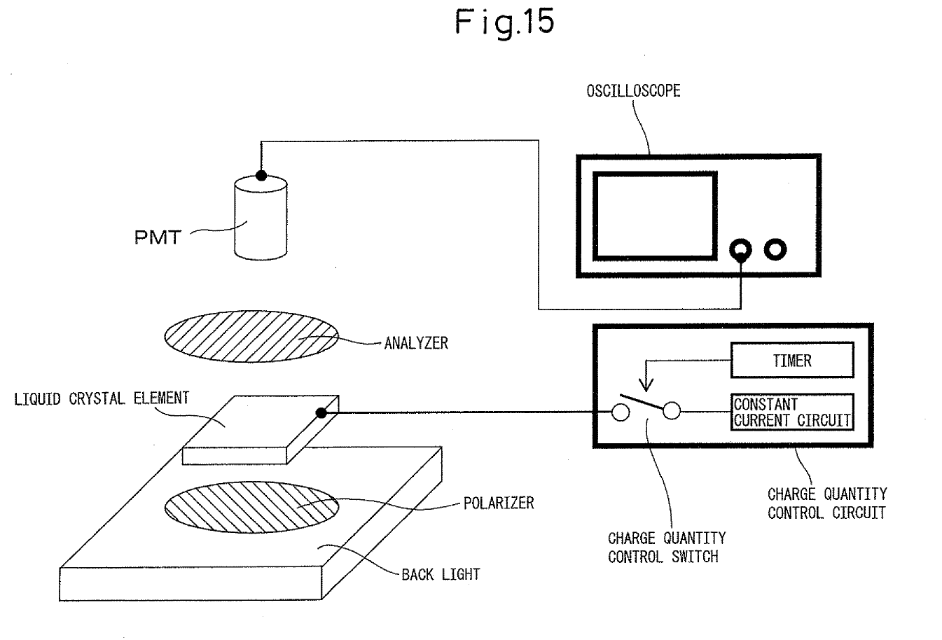

The charge quantity can be calculated by multiplying the electric current by the time, during which the electric current flows. Therefore, the charge quantity can be controlled by controlling the time for which the electric current is supplied from a constant current source between the electrodes of the liquid crystal element. FIG. 15 shows an example of the structure to confirm the alignment control based on the charge quantity by this method.

In the structure shown in FIG. 15, a constant electric charge quantity is supplied to the liquid crystal element from a charge quantity-controlling circuit comprising a constant current circuit, a timer, and a charge quantity-controlling switch. The alignment at this time is detected as a change in the optical response by using a PMT (photomultiplier), a polarization element (a polarizer and an analyzer), an oscilloscope, and a back light. If a change is detected in the optical response depending on the change in the electric charge quantity to be supplied to the liquid crystal element from a charge control circuit, it is possible to confirm that the alignment is controlled depending on the charge quantity.

### (Charge Supplier)

In the present invention, as a charge supplier for supplying electric charge to the above-mentioned liquid crystal element, a charge supplier, which can control the alignment of liquid crystal molecules, as will be discussed hereinafter, can be used without any limitations.

### (Examples of Charge Supplier)

In the present invention, for example, various types of charge suppliers as exemplified below, can be used.
a constant charge circuit
a constant current circuit
a capacitor
a charge-coupled device (CCD)

### (Usable Liquid Crystal Element)

As will be discussed hereinafter, the present invention can be applied to any liquid crystal elements, as long as the liquid crystal molecules can be aligned depending on the electric charge quantity to be supplied between a pair of electrodes, which are disposed opposite to each other by the medium of a liquid crystal material. However, in view of the fast response and good color rendering property, it is preferred to use a PSS-LCD (polarization-shielded smectic liquid crystal element) having the properties as discussed below, i.e., a liquid crystal element, wherein the initial molecular alignment in the liquid crystal material has a direction parallel or substantially parallel with the alignment treatment direction and which shows substantially no spontaneous polarization perpendicular to the pair of substrates, in the absence of an externally applied voltage.

### (Control of PSS-LCD)

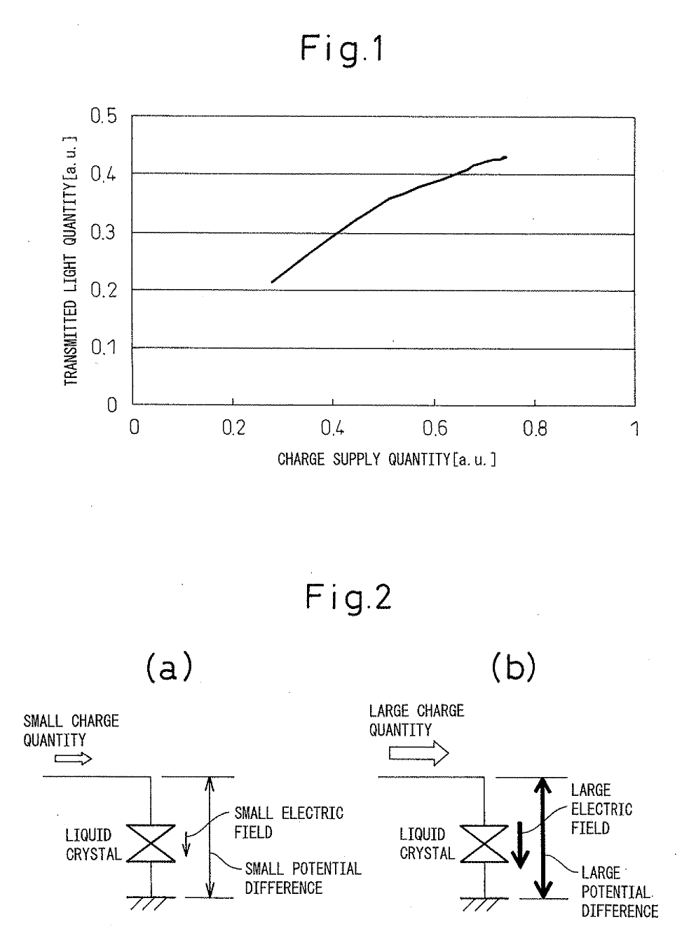

The present inventor has found that, even in a PSS-LCD having substantially no spontaneous polarization, the alignment can also be controlled by controlling the electric charge quantity to be supplied between the electrodes. FIG. 1 is a graph showing an example of the relationship between the quantity of charge supply and the quantity of the transmitted light, which has been obtained in the case of a PSS-LCD.

### (Mechanism of the Present Invention)

Generally, in a liquid crystal device, a voltage is applied to a dielectric substance (i.e., a liquid crystal material) disposed between a pair of electrodes to produce an optical response by the resultant electric field between the electrodes. That is, an electric field is provided to the dielectric substance (i.e., the liquid crystal) by applying a voltage to the parallel plate capacitor. However, in order to provide an electric field between the electrodes, it is necessary to supply electric charge therebetween.

For example, as shown in the conceptual view of FIG. 2 (a), when the charge quantity supplied between the electrodes is small, the potential difference between the electrodes is small and, accordingly, the electric field intensity provided by the potential difference is weak. In contrast, as shown in the conceptual view of FIG. 2 (b), when the quantity of charge to be supplied is large, the potential difference between the electrodes becomes large and the electric field intensity provided by the potential difference also becomes strong. The provision of a potential difference due to the application of a voltage and the provision of a potential difference due to the supply of electric charge appears to have the same meaning. However, it is appropriate to consider that the potential difference is essentially generated between the electrodes as a result of charge supply, and accordingly the provision of charge is a more accurate as a driving concept.

### An Embodiment Using PSS-LCD

In an embodiment according to the present invention using a PSS-LCD, the alignment of the liquid crystal can be changed, for example, by controlling time-differential value (i.e., dE/dt) of the electric field intensity. It is possible to control the time-differential value of an electric field intensity for the purpose of controlling the alignment of the liquid crystal, for example, by controlling the charge to be supplied between the electrodes.

In the PSS-LCD, a stable display quality can be achieved by controlling the electric charge quantity to be supplied thereto. For further improvement of the display quality, it is also possible to set the time-differential value dE/dt of the electric field intensity to an arbitrary value, by controlling the electric charge quantity to be supplied, whereby the range or latitude of gray scale display can be extended. The means or measure for precisely controlling the charge supply is not particularly limited. For example, the charge supply can be controlled by an improvement of the existing (or conventional) driving circuit, as discussed hereinafter.

### (TFT Element)

In the present invention, as means for supplying the charge to the above-mentioned liquid crystal element, those including a TFT may preferably be used.

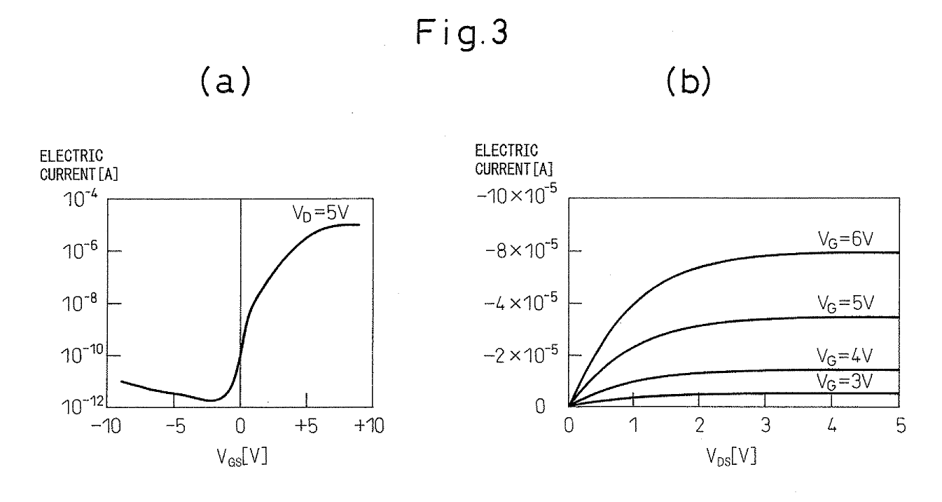

In the conventional TFT element, in general, the electric current to be supplied between the source and the drain can be determined depending on the intensity of the potential differences between the gate and the source, or between the gate and the drain, or between the source and the drain. FIG. 3 (a) shows a characteristic of the electric current corresponding to the potential difference between the gate and the source. As shown in FIG. 3 (a), it is understood that the electric current to be supplied is logarithmically increased along with the potential difference. On the other hand, FIG. 3 (b) shows an electric current characteristic with respect to the potential difference between the source and the drain. It can be seen in the figure that the degree of change in the electric current characteristic depending on the potential difference is smaller than that between the gate and the source, but that the larger the potential difference becomes, the larger the electric current which can be supplied. The charge can be obtained by the time integration of an electric current, the charge can be controlled by controlling the electric current. It could be understood that the electric current can be controlled by controlling the voltage between the gate and the source, between the gate and the drain, or between the source and the drain, in view of the above-mentioned current characteristic.

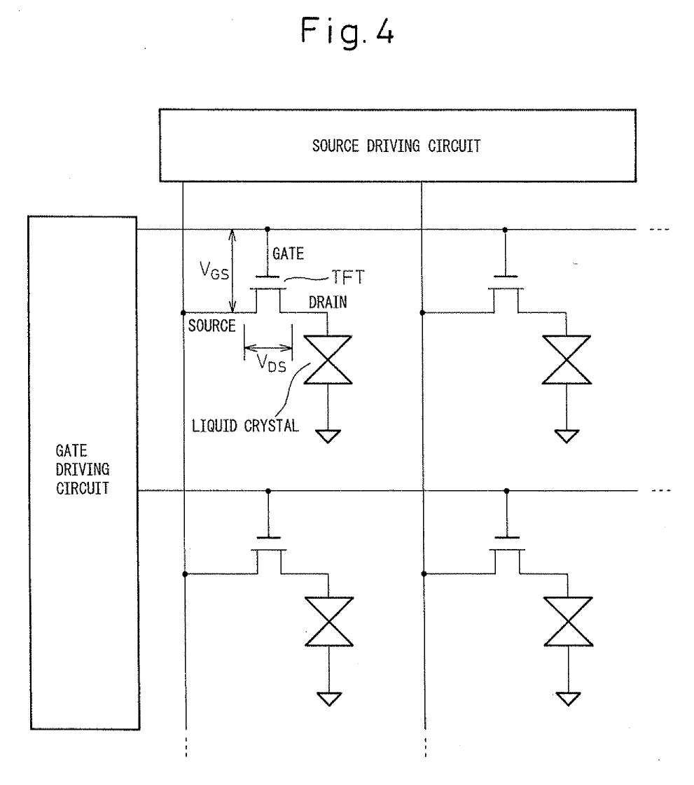

FIG. 4 is a schematic view showing a circuit of conventional TFT. When an image having plural gray scales is displayed by the TFTs, each TFT maintains the voltage corresponding to the gray scale of each pixel element constituting the image. When an image is changed, the voltage maintained by each TFT is also changed. Therefore, when a gate voltage is applied by outputting a voltage provided on the TFT source side from the source driving circuit, the voltage applied to the source side is maintained on the drain side. At this time, the voltage which is to be maintained in the subsequent step is applied, regardless of the voltage which has been previously maintained on the drain side. Therefore, it could be understood that, depending on the above-mentioned current characteristic, the potential difference between the source and the drain keeps changing along with the changing of the images to be displayed, and accordingly the current does not remain constant.

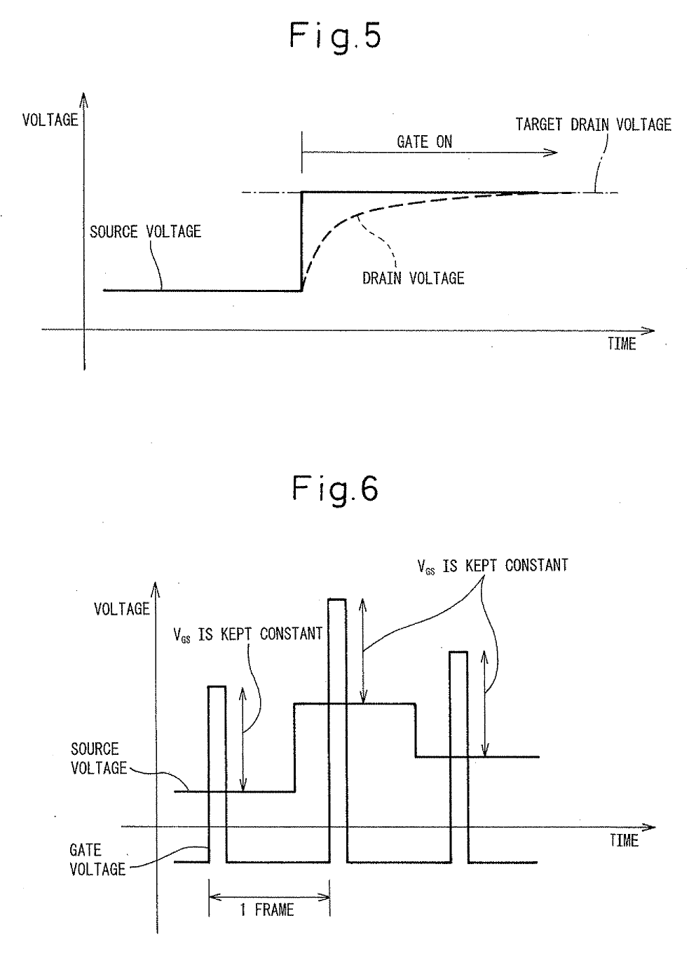

As illustrated by the schematic graph in FIG. 5, the potential difference between the source and the drain is decreased during the charge supply process. This is because the electric current to be supplied between the source and the drain is decreased along with a decrease in the potential difference between the drain and the source, as can be seen in the graph in FIG. 3 (b). As described above, the change in the electric current results in the change in the charge quantity to be supplied, and accordingly the fine control of the charge tends to be difficult.

### An Embodiment for Controlling Gate-On Time

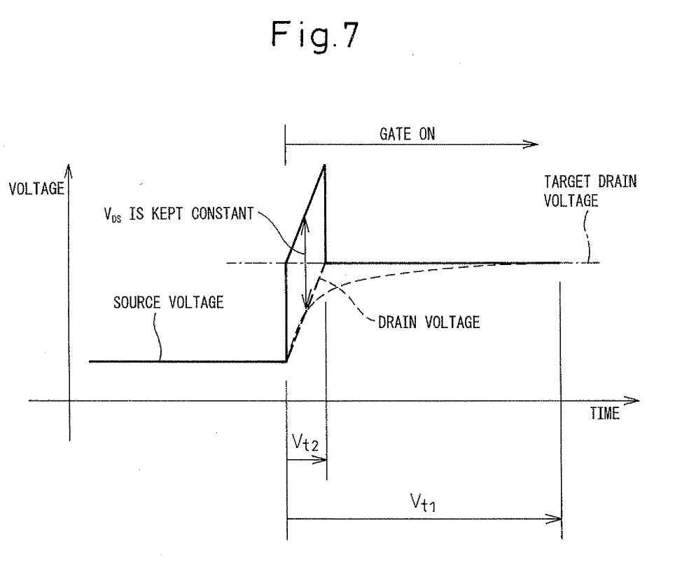

On the other hand, for example, as illustrated in a schematic graph in FIG. 6, it is possible to supply an almost constant electric current by adjusting the potential difference between the gate and the source at a constant value. Further, as illustrated in the schematic graph in FIG. 7, a substantially constant electric current can be obtained by adjusting the potential difference between the source and the drain at a constant value. When the electric current is constant, the charge quantity is dependent on the time during which the electric current is supplied. Therefore, the charge quantity can be controlled by adjusting the gate-on time.

### An Embodiment for Controlling Quantity of Charge Supply Per Unit Time

Further, the adjustment of each potential difference at an arbitrary voltage makes it possible to control the electric current at an arbitrary constant value, so that the quantity of charge supply per unit time can be arbitrarily selected.

### An Embodiment for Controlling Time-Differential Value of Electric Field

Thus, the rate of change in the liquid crystal potential difference on the drain side (i.e., the time-differential value of the electric field) can be arbitrarily selected.

### (An Example of Driving Circuit Structure for Controlling Gate-On Time)

A driving circuit for controlling the gate-on time, can be preferably comprise a circuit, wherein, as illustrated in the graph of FIG. 6, the gate voltage is changed while maintaining a constant potential difference, in association with the source voltage, and a circuit, wherein, as illustrated in a schematic graph of FIG. 7, the source voltage can be applied, in accordance with the drain voltage which is the potential difference due to the charge which has previously been provided in the previous pixel element. By use of such a driving circuit structure, more precise alignment control can be carried out in PSS-LCD.

### (An Example of Driving Circuit Structure for Time-Differential Value of the Electric Field Intensity)

In an embodiment according to the present invention using the PSS-LCD which can display gray scale by the time-differential value of the electric field intensity, further improved color rendering characteristic than that in the conventional LCDs can be provided by controlling the time-differential value of the electric field intensity.

In this embodiment, for example, the increasing or decreasing rate of the electric field intensity to be applied to the above-mentioned liquid crystal elements, with respect to time (time-differential value of the electric field intensity), can be controlled by controlling the electric charge quantity.

### (A Driving Circuit Structure for the Time-Differential Value of the Electric Field Intensity)

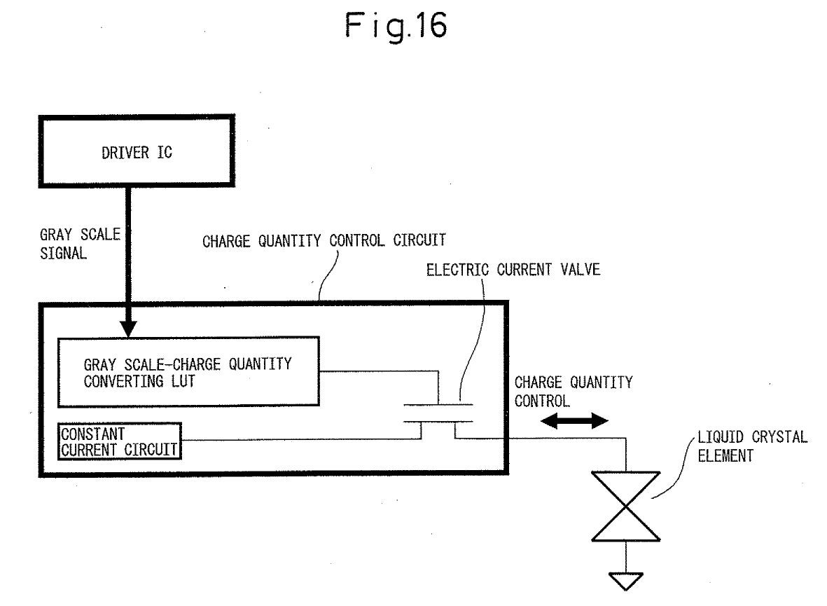

An example of the driving circuit arrangement for such an embodiment is shown in FIG. 16. In the circuit structure shown in FIG. 16, the gray scale signal is input to a charge quantity controlling circuit comprising a constant current circuit and a gray scale-charge quantity converting LUT, and, with a charge supply profile corresponding to the gray scale signal, the charge can be supplied to the liquid crystal element from the constant current circuit.

At this time, the charge supply profile refers to a change in the increasing rate or decreasing rate of the electric field intensity with respect to time by adjusting the charge quantity, in order to control the time-differential value of the electric field. That is, the larger the electric charge quantity to be supplied is, the larger the increasing rate of the electric field to be applied to the liquid crystal element with respect to time. On the other hand, the smaller the electric charge quantity to be supplied is, the smaller the increasing rate of the electric field to be applied to the liquid crystal element with respect to time. When the electric field is removed, the decreasing rate becomes larger, as the electric charge quantity to be fed back (i.e., the charge drawn by the charge quantity controlling circuit) is larger. On the other hand, the decreasing rate becomes smaller, as the electric charge quantity to be fed back is smaller. By use of such a structure, fine gray scale can be displayed by adjusting the change ratio of the electric field intensity to be actually applied to the liquid crystal element.

### (An Example of Driving Circuit Structure for Controlling Cumulative Quantity of Light for LCD)

In the present invention, the gray scale can also be displayed by continuously controlling the cumulative quantity of light for the LCD, by controlling the time-differential value of the electric field intensity to be applied to the liquid crystal element.

### (An Example of Driving Circuit Structure for Controlling Cumulative Quantity of Light Transmitted Through LCD)

An example of the driving circuit structure according to such an embodiment is basically the same as the driving circuit structure shown in FIG. 16. However, in this embodiment, the above-mentioned time-differential value of the electric field intensity may be controlled at a frame rate, which is a rewriting time for one picture and which is increased to exceed the time resolution of human eyes (for example, not more than about 16.7 msec., more preferably, not more than about 8.3 msec.), to display the gray scale by using the cumulative quantity of the transmitted light in each frame. By use of such a structure, further improvement in the gray scale display can be achieved more easily.

### (An Example of Driving Circuit Structure for Each Voltage/Gate-On Time Control of TFT)

In the present invention, the voltage and/or gate-on time for each TFT can also be controlled so as to control the time-differential value of the electric field intensity in the existing TFT.

### (An Example of Driving Circuit Structure for Each Voltage/Gate-On Time Control for TFT)

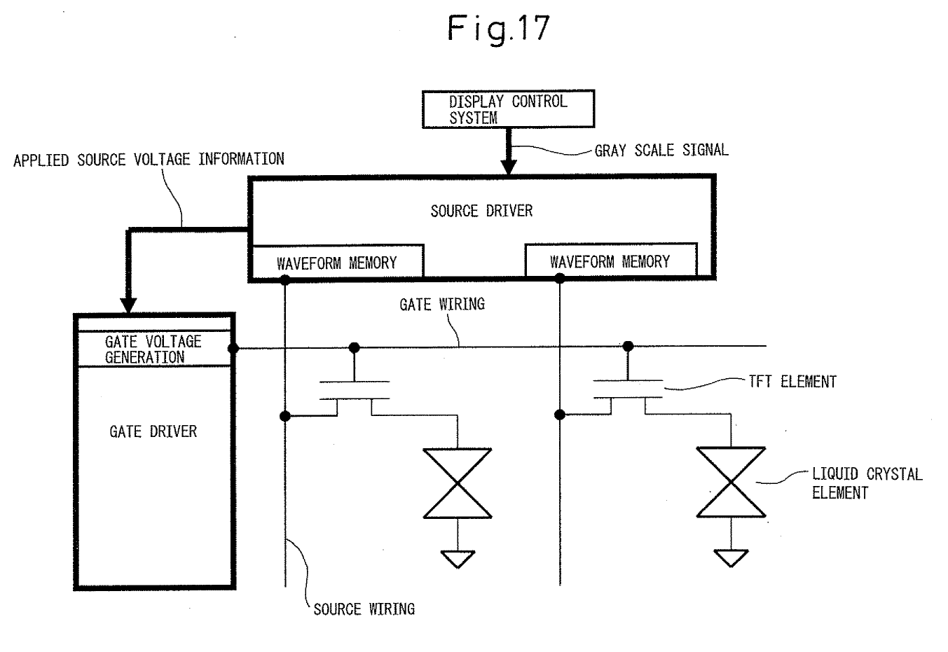

An example of a driving circuit structure for such an embodiment is shown in FIG. 17. In the circuit structure shown in FIG. 17, the source driver receives the gray scale signal from the display control system, to thereby control the source voltage to be applied to a TFT and the gate voltage which is a line-at-a-time writing signal. As mentioned above, there is a characteristic that, as the potential difference between the source voltage and the drain voltage, which is connected to the liquid crystal element, is reduced, the electric current to be supplied thereto is also reduced. Further, when the potential difference between the gate and the source voltage is smaller, similarly, the electric current to be supplied thereto also becomes smaller. Therefore, as shown in FIG. 7, the source driver always makes the source voltage and the drain voltage constant. Based on the applied source voltage at that time, the gate voltage is adjusted, as shown in FIG. 6, so that the gate voltage and the source voltage become constant. Here, it is necessary to detect the applied source voltage in order to provide the gate voltage, and accordingly, the source voltage waveform should be generated in advance. The applied source waveform is recorded in a memory, so that the source voltage can be applied at the same time as the application of the gate voltage. Since the generated gate voltage is always controlled to give a constant electric current, the changing of the gate-on time can result in an arbitrary gray scale display.

For an embodiment wherein a conventional TFT is used, the present technique can be simply applied thereto by a design change in each driver IC.

### (Easy Realization of High Resolution)

When the potential differences to be set constant between the source and the gate, and the source and the drain are fixed to the voltage for providing a good electric characteristic, the drain voltage reaches a target (or intended) voltage faster, resulting in the reduction of the gate-on time and the gate scan time. This means that the high resolution is easily achieved.

### (Applicability to Other Liquid Crystal Elements)

The above explanation of the basic concept according to the present invention has been mainly directed, for the sake of convenience, to an embodiment using the electric optical response of PSS-LCD (which is advantageous from the viewpoint of color rendering characteristic). However, the present invention is also applicable to any liquid crystal element in addition to PSS-LCD, as long as liquid crystal molecules can be aligned in accordance with the charge supplied between the electrodes. In view of the enhancement of the effect according to the present invention, the liquid crystal element having a sufficient response speed may be preferably used.

### (Polarizing Element)

As for the polarizing element usable in the present invention, a polarizing element conventionally used for fabricating a liquid crystal device can be used without any particular limitation. The shape, size, constituent element and the like thereof are also not particularly limited.

### (Suitable Polarizing Element)

Examples of the polarizing element which can be suitably used in the present invention include the following:

π-Cell: Molecular Crystals and Liquid Crystals, Vol. 113, page 329 (1984), Phil Bos and K. R. Kehler-Beran
glass polarizing filter
polarizing filter
polarizing prism
reflective polarizer

### (Liquid Crystal Element)

The liquid crystal element according to an embodiment of the present invention comprises a pair of substrates and a liquid crystal material disposed between the pair of substrates.

### (Liquid Crystal Material)

In the present invention, a liquid crystal material can be used without any particular limitation as long as it is a liquid crystal material capable of constituting an electro-optical element in which the optical axis azimuth is rotated in response to the strength and/or direction of an electric field to be applied thereto for applying the system of the present invention. Whether or not a certain liquid crystal material is usable in the present invention can be confirmed by the following “Confirmation Method for Optical Axis Azimuth Rotation”. Also, in the present invention, a liquid crystal material capable of a predetermined high-speed response is suitably usable and whether or not a certain liquid crystal material can response at a sufficiently high speed can be confirmed by the following “Confirmation Method for Response Time”.

### (Confirmation Method for Optical Axis Azimuth Rotation)

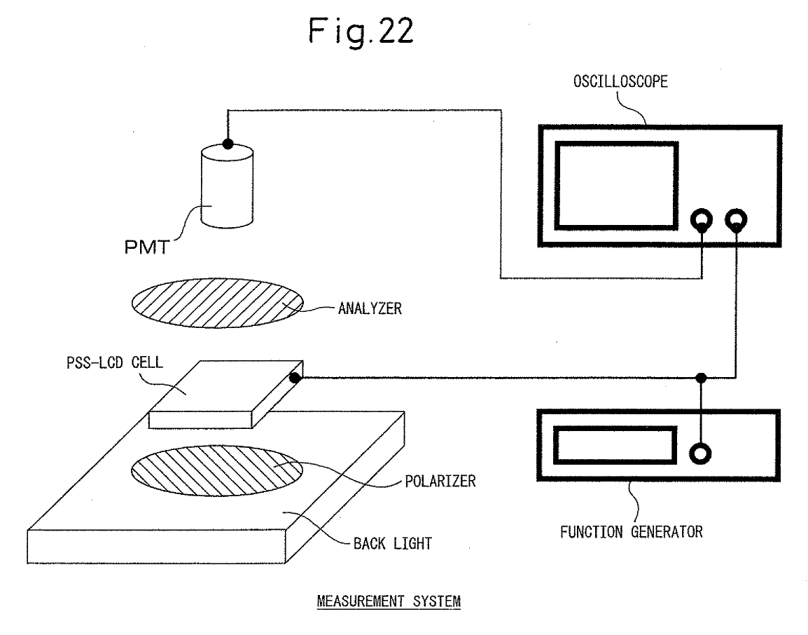

In regard to the method for measuring the optical axis azimuth rotation as a liquid crystal element, in the case of disposing a liquid crystal element in the cross-Nicol arrangement where a polarizer is disposed perpendicularly to an analyzer, when the optical axis agrees with the absorption axis of the analyzer, the intensity of transmitted light becomes minimum. Accordingly, the angle at which the minimum intensity of transmitted light in the cross-Nicol arrangement is obtained becomes the angle of optical axis azimuth. At this time, an electric field is not applied to the liquid crystal element. Using this angle as a reference angle, an angle at which the minimum intensity of transmitted light in the cross-Nicol arrangement is obtained when applying an electric field to the liquid crystal element is sought for. When an angle giving a minimum intensity upon application of an electric field is present and the angle giving a minimum intensity is an angle slipped from the reference angle and when the strength or direction of the electric field is varied and an increase or decrease of the rotation angle in accordance with the variation is observed, it can be confirmed that the optical axis direction is rotated. As regards the apparatus for confirmation, similarly to the confirmation method for optical axis azimuth, the rotation can be confirmed, for example, by an apparatus having a construction of FIG. 22.

### (Confirmation Method for Response Time)

In the case where optical axis azimuth rotation is observed in the liquid crystal element, the speed of this rotation comes under the response time. A liquid crystal element is disposed at an angle giving a minimum transmitted light quantity in the cross-Nicol arrangement where a polarizer is disposed perpendicularly to an analyzer, and an electric field is applied to the liquid crystal element. The optical axis azimuth is rotated upon application of an electric field and therefore, the transmitted light quantity is changed. The degree of change in the transmitted light quantity becomes the degree of change in the rotation. Assuming that the transmitted light quantity in the state of an electric field being not applied is 0% and the transmitted light quantity that is changed by the application of an electric field and finally reaches a steady state is 100%, the time necessary for the transmitted light quantity to rise from 10% to 90% when an electric field is applied from the state of an electric field being not applied is designated as a rise-up response time, and the time necessary for the transmitted light quantity to drop from 90% to 10% when application of an electric field is stopped from the state of an electric field being applied is designated as a rise-down response time. For example, in PSS-LCD, the rise-up response time and the rise-down response time both are about 400 μs. As regards the apparatus for confirmation, similarly to “Confirmation Method for Optical Axis Azimuth”, the response time can be confirmed, for example, by an apparatus having a construction of FIG. 22.

### (PSS-LC)

The liquid crystal material which is preferably usable in the present invention is a PSS-LC, wherein the molecular initial alignment in the liquid crystal material has an almost parallel direction with respect to the alignment treatment direction; and the liquid crystal material shows substantially no spontaneous polarization which is at least perpendicular to a pair of substrates, under the absence of an externally applied voltage.

### (Molecular Initial Alignment)

In the present invention, in the molecular initial alignment (or orientation) in the liquid crystal material, the major axis of the liquid crystal molecules has an almost parallel direction with respect to the alignment treatment direction for the liquid crystal molecules. The fact that the major axis of the liquid crystal molecules has an almost parallel direction with respect to the alignment treatment direction can be confirmed, e.g., by the following manner.

In order to enable the liquid crystal device according to the present invention to exhibit a desirable display performance, the angle (absolute value) between the rubbing direction and the alignment direction of the liquid crystal molecules, which has been measured by the following method may preferably be 3 degrees or less, more preferably be 2 degrees or less, particularly 1 degree or less.

In a strict sense, it is known that when a polymer alignment film such as polyimide film is subjected to rubbing, a birefringence is induced in the polyimide outermost layer, to thereby provide a slow optical axis. Further, in general, it is known that the major axis of the liquid crystal molecules are aligned in parallel with the slow optical axis. With respect to almost all of the polymer alignment films, it is known that a certain gap in the angle occurs between the rubbing direction and the slow optical axis. In general, the gap is relatively small and may be about 1-7 degrees.

However, this gap in the angle can be 90 degrees as in the case of polystyrene as an extreme example.

Therefore, in the present invention, the angle between the rubbing direction and the alignment direction of the major axis (i.e., optical axis) of the liquid crystal molecules may preferably be 3 degrees or less. At this time, the alignment direction of the major axis of the liquid crystal molecules, and the slow optical axis which has been provided in the polymer (such as polyimide) polymer alignment film by rubbing, etc., may preferably be 3 degrees or less, more preferably 2 degrees or less, particularly 1 degree or less.

As described above, in the present invention, the alignment treatment direction refers to the direction of the slow optical axis (in the polymer outermost layer) which determines the direction of the alignment of the liquid crystal molecule major axis.

### <Method of Measuring Molecular Initial Alignment State for Liquid Crystal Molecules>

In general, the major axis of liquid crystal molecules is in fair agreement with the optical axis. Therefore, when a liquid crystal panel is placed in a cross Nicole arrangement wherein a polarizer is disposed perpendicular to an analyzer, the intensity of the transmitted light becomes the smallest when the optical axis of the liquid crystal is in fair agreement with the absorption axis of the analyzer. The direction of the initial alignment axis can be determined by a method wherein the liquid crystal panel is rotated in the cross Nicole arrangement while measuring the intensity of the transmitted light, whereby the angle providing the smallest intensity of the transmitted light can be determined.

<Method of Measuring Parallelism of Direction of Liquid Crystal Molecule Major Axis with Direction of Alignment Treatment>

The direction of rubbing is determined by a set angle, and the slow optical axis of a polymer alignment film outermost layer which has been provided by the rubbing is determined by the kind of the polymer alignment film, the process for producing the film, the rubbing strength, etc. Therefore, when the extinction position is provided in parallel with the direction of the slow optical axis, it is confirmed that the molecule major axis, i.e., the optical axis of the molecules, is in parallel with the direction of the slow optical axis.

### (Spontaneous Polarization)

In the present invention, in initial molecular alignment, the spontaneous polarization (which is similar to the spontaneous polarization in the case of a ferroelectric liquid crystal) is not provided, at least with respect to the direction which is perpendicular to the substrate. In the present invention, the “initial molecular alignment providing substantially no spontaneous polarization is such that the spontaneous polarization does not occur” can be confirmed, e.g., by the following method.

### <Method of Measuring Presence of Spontaneous Polarization Perpendicular to the Substrate>

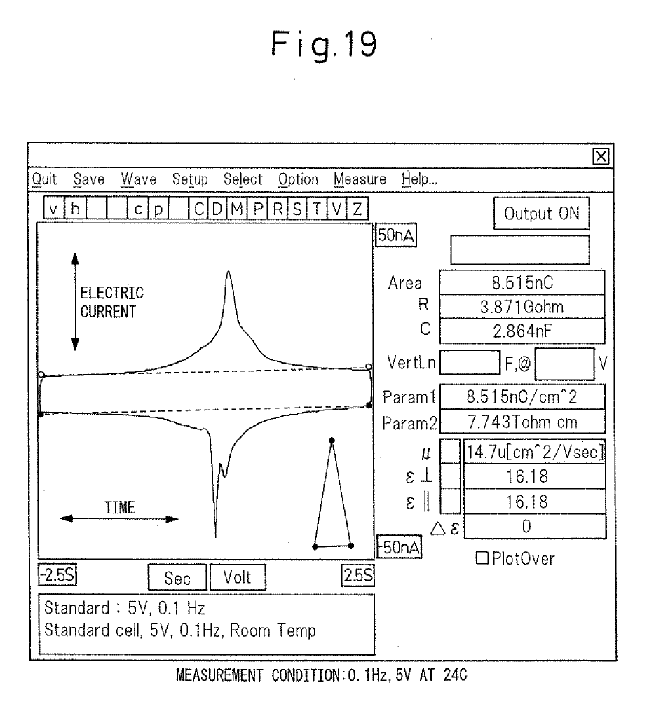

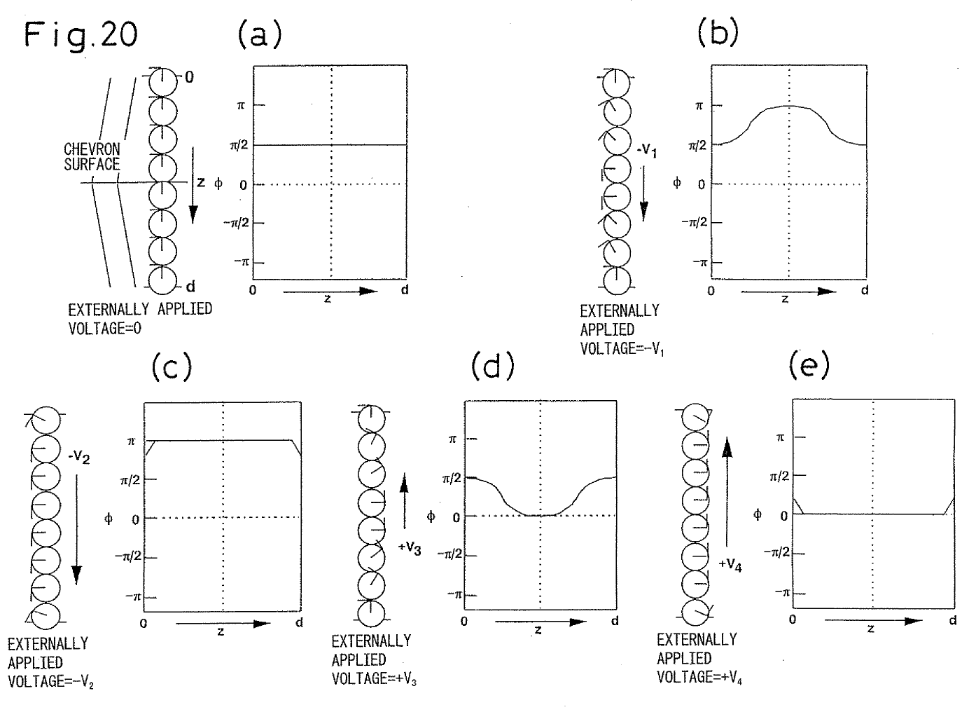

In a case where the liquid crystal in a liquid crystal cell has a spontaneous polarization, particularly in a case where a spontaneous polarization is provided in the substrate direction in the initial state, namely in the direction perpendicular to the electric field direction in the initial state (i.e., under the absence of an external electric field), when a low-frequency triangular voltage (about 0.1 Hz) is applied to the liquid crystal cell, the direction of the spontaneous polarization is reversed from the upper direction into the lower direction, or from the lower direction into the upper direction, along with the change in the polarity of the applied voltage from positive into negative, or from negative into positive. Along with such an inversion, actual electric charge is transported (i.e., an electric current is provided). The spontaneous polarization is reversed, only when the polarity of the applied electric field is reversed. Therefore, there appears a peak-shaped electric current as shown in FIG. 19.

The integral value of the peak-shaped electric current corresponds to the total quantity electric charges to be transported, i.e., the strength of the spontaneous polarization. When no peak-shaped electric current is observed in this measurement, the absence of the occurrence of the spontaneous polarization inversion is directly proved by such a phenomenon.

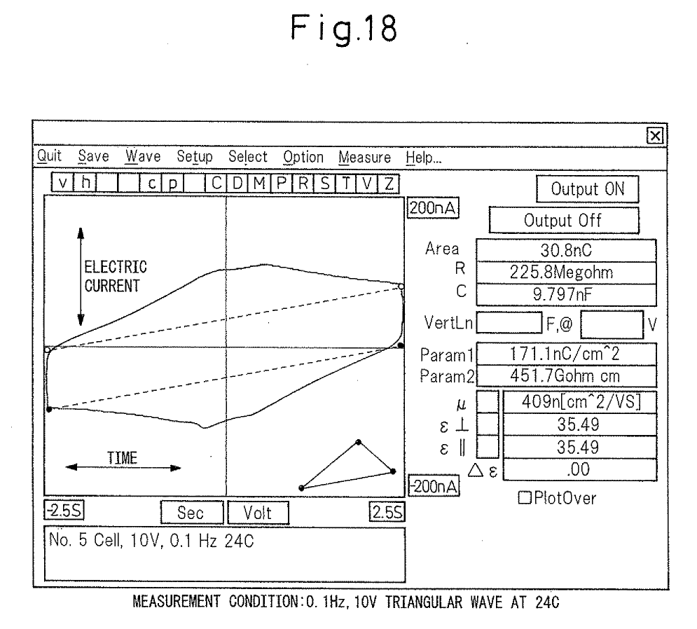

Further, when a linear increase in the electric current as shown in FIG. 18 is observed, it is found that the major axis of the liquid crystal molecules is continuously or consecutively changed in the molecular alignment direction thereof, depending on the increase in the electric field intensity. In other words, in this case as shown in FIG. 18, it has been found that there occurs a change in the molecular alignment direction due to induced polarization, etc., depending on the intensity of the applied electric field.

### (Substrate)

The substrate usable in the present invention is not particularly limited, as long as it can provide the above-mentioned specific “molecular initial alignment state”. In other words, in the present invention, a suitable substrate can appropriately be selected, in view of the usage or application of LCD, the material and size thereof, etc. Specific examples thereof usable in the present invention are as follows.

A glass substrate having thereon a patterned a transparent electrode (such as ITO)

An amorphous silicon TFT-array substrate

A low-temperature poly-silicon TFT array substrate

A high-temperature poly-silicon TFT array substrate

A single-crystal silicon array substrate

### Preferred Substrate Examples

Among these, it is preferred to use following substrate, in a case where the present invention is applied to a large-scale liquid crystal display panel.

An amorphous silicon TFT array substrate

### (PSS-LC Material)

The PSS-LC material usable in the present invention is not particularly limited as long as it can provide the above-mentioned specific “molecular initial alignment state”. In other words, in the present invention, a suitable liquid crystal material can appropriately be selected, in view of the physical characteristic, electric or display performance, etc. For example, various liquid crystal materials (including various ferroelectric or non-ferroelectric liquid crystal materials) as exemplified in a publication of may in general be used in the present invention. Specific preferred examples of such liquid crystal materials usable in the present invention are as follows.

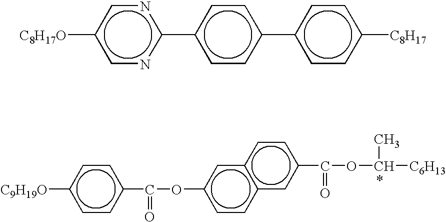

### Preferred Liquid Crystal Material Examples

Among these, it is preferred to use the following liquid crystal material, in a case where the present invention is applied to a projection-type liquid crystal display.

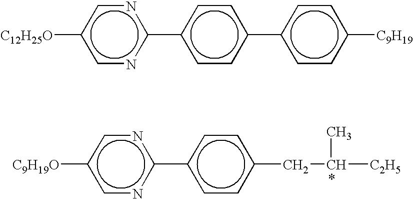

### (Alignment Film)

The alignment film usable in the present invention is not particularly limited as long as it can provide the above-mentioned specific “molecular initial alignment state”. In other words, in the present invention, a suitable alignment film can appropriately be selected, in view of the physical characteristic, electric or display performance, etc. For example, various alignment films as exemplified in publications may in general be used in the present invention. Specific preferred examples of such alignment films usable in the present invention are as follows.

Polymer alignment film: polyimides, polyamides, polyamide-imides

Inorganic alignment film: SiO2, SiO, Ta205, etc.

### Preferred Alignment Film Examples

Among these, it is preferred to use the following alignment film, in a case where the present invention is applied to a projection-type liquid crystal display.

Inorganic Alignment Films

In the present invention, as the above-mentioned substrates, liquid crystal materials, and alignment films, it is possible to use those materials, components or constituents corresponding to the respective items as described in “Liquid Crystal Device Handbook” (1989), published by The Nikkan Kogyo Shimbun, Ltd. (Tokyo, Japan), as desired.

### (Other Constituents)

The other materials, constituents or components, such as transparent electrode, electrode pattern, micro-color filter, spacer, and polarizer, to be used for constituting the liquid crystal display according to the present invention, are not particularly limited, unless they are against the purpose of the present invention (i.e., as long as they can provide the above-mentioned specific “molecular initial alignment state”). In addition, the process for producing the liquid crystal display device which is usable in the present invention is not particularly limited, except the liquid crystal display device should be constituted so as to provide the above-mentioned specific “molecular initial alignment state”. With respect to the details of various materials, constituents or components for constituting the liquid crystal display device, as desired, “Liquid Crystal Device Handbook” (1989), published by The Nikkan Kogyo Shimbun, Ltd. (Tokyo, Japan) may be referred to.

### (Means for Realizing Specific Initial Alignment)

The means or measure for realizing such an alignment state is not particularly limited, as long as it can realize the above-mentioned specific ‘molecular initial alignment state”. In other words, in the present invention, a suitable means or measure for realizing the specific initial alignment can appropriately be selected, in view of the physical characteristic, electric or display performance, etc.

The following means may preferably be used, in a case where the present invention is applied to a large-sized TV panel, a small-size high-definition display panel, and a direct-view type display.

### (Preferred Means for Providing Initial Alignment)

According to the present inventor' investigation and knowledge, the above-mentioned suitable initial alignment may easily be realized by using the following alignment film (in the case of baked film, the thickness thereof is shown by the thickness after the baking) and rubbing treatment. On the other hand, in ordinary ferroelectric liquid crystal displays, the thickness of the alignment film 3,000 A (angstrom) or less, and the strength of rubbing (i.e., contact length of rubbing) 0.3 mm or less.

Thickness of alignment film: preferably 4,000 A or more, more preferably 5,000 A or more (particularly, 6, 000 A or more)

Strength of rubbing (i.e., contact length of rubbing): preferably 0.3 mm or more, more preferably 0.4 mm or more (particularly, 0.45 mm or more)

The above-mentioned alignment film thickness and strength of rubbing may be measured, e.g., in a manner as described in Production Example 1 appearing hereinafter (Usable PSS-LCD; Another embodiment 1)

According to another embodiment, there is provided: a liquid crystal device (i.e., PSS-LCD) comprising: at least, a pair of substrates; a liquid crystal material disposed between the pair of substrates; and a pair of polarizing films disposed on the outside of the pair of substrates; wherein one of the pair of polarizing films has a molecular initial alignment which is parallel or almost parallel with the alignment treatment direction for the liquid crystal material; the other of the pair of polarizing films has a polarizing absorption direction which is perpendicular to the alignment treatment direction for the liquid crystal material; and, the liquid crystal device shows an extinction angle under the absence of an externally applied voltage.

The liquid crystal display according to such an embodiment has an advantage that the extinction position thereof does not substantially have a temperature dependency, in addition to those as described above.

Therefore, in this embodiment, it is possible to make the temperature dependency of the contrast ratio relatively small.

In the above-mentioned relationship wherein the polarizing absorption axis direction of the polarizing film is substantially aligned with the alignment treatment direction of the liquid crystal material, the angle between the polarizing absorption axis direction of the polarizing film and the alignment treatment direction of the liquid crystal material may preferably be 2 degrees or less, more preferably 1 degree or less, particularly 0.5 degree or less.

In addition, the phenomenon that the liquid crystal device shows an extinction position under the absence of an externally applied voltage may be confirmed, e.g., by the following method.

### <Method of Confirming Extinction Position>

A liquid crystal panel to be examined is inserted between a polarizer and an analyzer which are disposed in cross-Nicole relationship, and the angle providing the minimum light quantity of the transmitted light is determined while the liquid crystal panel is being rotated. The thus determined angle is the angle of the extinction position.

### Usable PSS-LCD; Another Embodiment 2

According to a further embodiment, there is provided: a liquid crystal device (i.e., PSS-LCD) comprising: at least, a pair of substrates; and a liquid crystal material disposed between the pair of substrates; wherein the current passing through the pair of substrates shows substantially no peak-shaped current, when a continuously and linearly changing voltage waveform is applied to the liquid crystal device.

The current passing through the pair of substrates does not substantially show a peak-shaped current, under the application of a voltage waveform of which strength is continuously and linearly changed, may be confirmed, e.g., by the following method.

In this embodiment, “the current does not substantially show a peak-shaped current” means that, in the liquid crystal molecule alignment change, the spontaneous polarization does not participate in the liquid crystal molecule alignment change, at least in a direct manner. The liquid crystal display according to such an embodiment has an advantage, in addition to those as described above, that it enables sufficient liquid crystal driving, even in a device having the lowest electron mobility such as amorphous silicon TFT array device among active driving devices.

Even when the liquid crystal per se can exhibit a considerably high display performance, if the capacity thereof is relatively large, it is difficult to drive such a liquid crystal by using an amorphous silicon TFT array device having a limit on the electron mobility. As a result, it is actually impossible to provide high-quality display performance. Even in this case, in view of the ability of driving the liquid crystal, it is possible to provide sufficient display performance, by using low-temperature polysilicon and high-temperature polysilicon TFT array devices having a lager electron mobility than amorphous silicon; or single crystal silicon (silicon wafer) capable of providing the maximum electron mobility.

On the other hand, the amorphous silicon TFT array is economically advantageous in view of the production cost. Further, when the size of the panel is increased, the economic advantage of the amorphous silicon TFT array is much greater than the other types of active devices.

### <Method of Confirming Peak-Shaped Current>

A triangular wave voltage having an extremely low frequency of about 0.1 Hz is applied to a liquid crystal panel to be examined. The liquid crystal panel would sense such an applied voltage so that a DC voltage is increased and decreased almost linearly. When the liquid crystal in the panel shows a ferroelectric liquid crystal phase, the optical response, and charge transfer state are dependent on the polarity of the triangular wave voltage, but not substantially dependent on the crest value (or peak-to-peak value) of the triangular wave voltage. In other words, due to the presence of the spontaneous polarization, the spontaneous polarization of the liquid crystal is coupled with the externally applied voltage, only when the polarity of the applied voltage is changed from negative to positive, or from positive to negative. When the spontaneous polarization is reversed, electric charges are temporarily transferred so as to provide a peak-shaped electric current in the inside of the panel. On the contrary, if the reverse of the spontaneous polarization does not occur, no peak-shaped electric current is observed, and the current shows a monotonous increase, decrease or a constant value.

Therefore, the polarization of the panel may be determined by applying a low-frequency triangular wave voltage to the panel and precisely measuring the resultant current, to thereby determine the profile of the current wave form.

### Usable PSS-LCD; Another Embodiment 3

According to a further embodiment of the present invention, there is provided: a liquid crystal device (i.e., PSS-LCD) wherein the liquid crystal molecular alignment treatment for the liquid crystal material is conducted in conjunction with a liquid crystal molecular alignment material providing a low surface pre-tilt angle.

In this embodiment, the pre-tilt angle may preferably be 1.5 degrees or less, more preferably 1.0 degree or less (particularly 0.5 degree or less). The liquid crystal display according to such an embodiment has an advantage, in addition to those describe above, that it can provide uniform alignment in a wide area, and a wide view angle.

The reason why the wide view angle is provided is as follows.

In the liquid crystal molecule alignment according to the present invention, liquid crystal molecules may be moved within cone-like regions, and the electro-optical response thereof does not remain in the same plane.

Generally, when such molecular movement out of the plane is caused, the incidence angle dependency of birefringence occurs, and the viewing angle is narrowed.

However, in the liquid crystal molecule alignment according to the present invention, the molecular optical axis of liquid crystal molecules may always be moved in the clockwise or counter-clockwise direction, symmetrically and at a high-speed, with respect of the top of cones, as shown in FIG. 22. Due to the high-speed symmetrical movement, an extremely symmetrical image may be obtained as a result of time-averaging.

Therefore, with respect to the viewing angle, this embodiment can provide images having high symmetry and a small angle dependency.

### Usable PSS-LCD; Another Embodiment 4

According to a further embodiment of the present invention, there is provided: a liquid crystal device (i.e., PSS-LCD) wherein the liquid crystal material shows Smectic A phase to the ferroelectric liquid crystal phase sequence.

In this embodiment, the phenomenon that the liquid crystal material has a “Smectic A phase to the ferroelectric liquid crystal phase sequence” can be confirmed, e.g., by the following method. The liquid crystal display according to such an embodiment has an advantage, in addition to those as described above, that it can provide a higher upper limit of the storage temperature therefor. More specifically, in a case where the upper limit of the storage temperature for the liquid crystal display is intended to be determined, even when the temperature exceeds the transition temperature for the ferroelectric liquid crystal phase to Smectic A phase, it can return to the ferroelectric liquid crystal phase so as to restore the initial molecular alignment, unless the temperature exceeds the transition temperature for the smectic A phase to cholesteric phase.

### <Method of Confirming Phase Transition Sequence>

The phase transition sequence of the smectic liquid crystal may be confirmed as follows.

Under a cross Nicole relationship, the temperature of a liquid crystal panel is lowered from the isotropic phase temperature. At this time, the buffing direction is made in parallel with the analyzer. As a result of the observation by a polarizing microscope, a birefringence change wherein a firework-like shape is changed into a round shape is first measured. When the temperature is further decreased, an extinction direction occurs in parallel with the buffing direction. When the temperature is further decreased, and the phase is converted into a so-called ferroelectric liquid crystal phase. In this phase, when the panel is rotated by an angle of 3-4 degree about in the vicinity of the extinction position, it is found that the transmitted light intensity is increased when the position is outside of the extinction position, along with a decrease in the temperature.

Herein, it is possible to confirm the helical pitch of a ferroelectric liquid crystal phase and the panel gap of the substrates, e.g., by the following method.

### <Method of Confirming Helical Pitch>

In a cell having substrates which have been buffed so as to provide alignment treatments in parallel with each other, a liquid crystal material is injected between panels having a cell gap which is at least five times the expected helical pitch. As a result, a striped pattern corresponding to the helical pitch appears in the display surface.

### <Method of Confirming Panel Gap>

Before the injection of a liquid crystal material, the panel gap may be measured by using a liquid crystal panel gap measuring device utilizing light interference.

### (Measuring Method for Optical Axis Azimuth Angle and Construction of Apparatus)

In regard to the method of exactly measuring the optical axis azimuth as a liquid crystal element, in the case of disposing a liquid crystal element in the cross-Nicol arrangement where a polarizer is disposed perpendicularly to an analyzer, when the optical axis agrees with the absorption axis of the analyzer, the intensity of transmitted light becomes minimum. Accordingly, the angle at which the minimum intensity of transmitted light in the cross-Nicol arrangement is obtained becomes the angle of optical axis azimuth. Example of the measuring apparatus include a polarizing microscope equipped with a photodetection element such as PMT (photomultiplier tube) in the tube part.

The schematic perspective view of FIG. 24 shows one example of the construction of components suitable for the exact measurement of optical axis azimuth. The polarizer and analyzer of the polarizing microscope are laid in the cross-Nicol arrangement, a liquid crystal element to be measured is disposed on the sample stage by disposing the reference angle to be the same as the absorption axis angle of the analyzer, and the sample stage is rotated to make minimum the light quantity detected by PMT. The angle of the sample stage here becomes the optical axis azimuth angle with respect to the reference angle of the liquid crystal element.

(Mechanism for Correcting Capacitance Change in Liquid crystal Element)

It is known that, in general, the capacitance of a liquid crystal is changed depending on the voltage applied thereto. It is also known that the capacitance change has a time delay. Therefore, the electric charge quantity to be supplied should be determined while taking into consideration the capacitance change in the liquid crystal so as to precisely control the charge quantity.

### (Correction of Capacitance Change in Liquid Crystal Element)

It is known that, in general, when an electric field is applied, the dielectric constant thereof changes since the alignment of liquid crystal material is changed. It is also known that the change in dielectric constant has a time delay. Therefore, the capacitance of a liquid crystal element, wherein a liquid crystal material is disposed between electrodes, is also changed. When the capacitance is changed, the charge quantity should be adjusted to maintain the applied electric field. And, in many cases, the capacitance change is non-linear. Because of this, to more precisely control the charge quantity, the electric charge quantity to be supplied should be determined while taking the capacitance change in the liquid crystal element into consideration.

### (Method of Confirming the Capacitance Change in Liquid Crystal Element)

The capacitance change in a liquid crystal element to be used can be directly confirmed by the measurement of the dependence of the liquid crystal element capacitance upon the applied voltage. Moreover, the capacitance change can be derived from the applied voltage dependence of the liquid crystal element capacitance, measured with reference to the method described in “Ekisho Kiso-hen (Liquid Crystal basic course)”, Mitsuharu Okano and Shunsuke Kobayashi, 1985, 1^{st} edition, page 215 “Measurement of resistivity and dielectric constant”, published by Baifukan. Regarding the applied voltage dependence of the capacitance measured, the charge quantity necessary for the liquid crystal element at each electric field (i.e., each gray scale) can be calculated from an equation,

C(capacitance)=Q(charge quantity)/V(voltage),

representing the capacitance of a capacitor.

The measuring apparatus can be appropriately selected in view of the measuring method, performance, characteristic, etc., from those that can measure the capacitance and change the voltage to be applied to the liquid crystal element for measurement. For example, an LCR meter 4284A, made by Agilent, can be used.

### (Charge Supply Method in Consideration of Capacitance Change)

A charge supply method wherein the capacitance change is taken into account is described. The resulting charge quantity necessary at each electric field obtained by the above-mentioned confirmation method is recorded in, for example, an LUT (Look Up Table) to convert the same into an appropriate charge quantity based on the pixel element gray scale information. By applying the converted charge quantity, a more precise gray scale display is possible.

### (Charge Supplier Circuit Structure Based on the Capacitance Change)

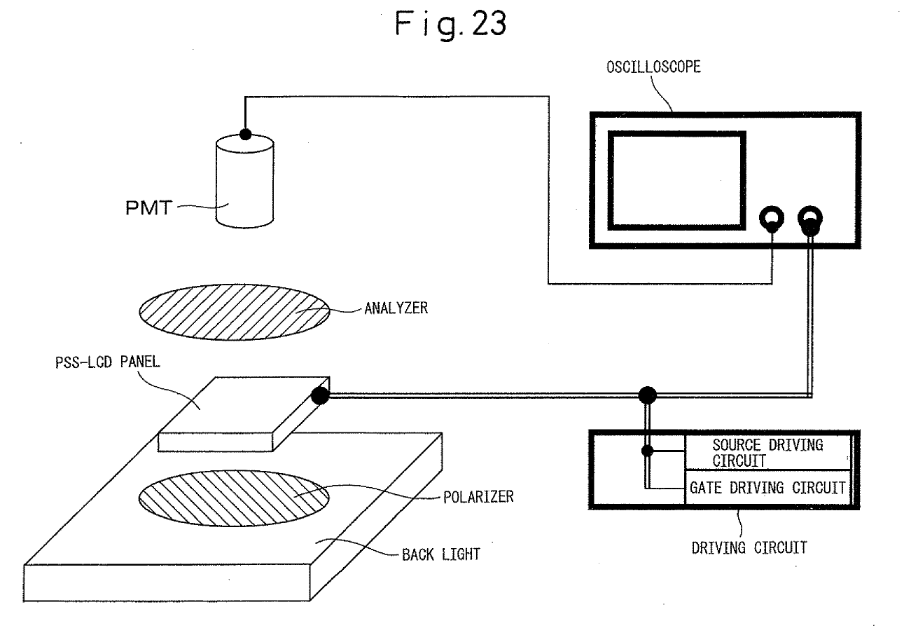

FIG. 23 shows an example of driving circuit structure for such an embodiment. In the circuit structure, the gray scale signal is input to a charge quantity-controlling circuit comprising a constant current circuit and gray scale-charge quantity conversion LUT, so that the charge quantity corresponding to the gray scale signal is supplied from the constant current circuit to the liquid crystal element. At that time, the charge quantity corresponding to the gray scale signal represents the charge quantity necessary at each electric field in response to the capacitance change. The structure such as this can display a more precise gray scale.

### EXAMPLES

### Production Example 1

Using commercially available FLC mixture material (Merck: ZLI-4851-100), photo-curable liquid crystalline material (Dai-Nippon Ink Chemicals: UCL-001), and photo initiator material (Merck: Darocur 1173), in response to JP-A H11-21554 (Japanese Paten Appln. H09-174463), PS-V-FLCD panel was fabricated. The mixture had 93 mass % of ZLI-4851-100 FLC mixture, 6 mass % of UCL-001, and 1 mass % of Darocur 1173.

The substrate used herein was a glass substrate (borosilicate glass, thickness 0.7 mm, size: 50 mm×50 mm; available from Nano Loa Inc.) having thereon an ITO film.

The polyimide alignment film was formed by applying a polyimide alignment material by use of a spin coater, then preliminarily baking the resultant film, and finally baking the resultant product in a clean oven. With respect to the details of the general industrial procedure to be used herein, as desired, a publication “Liquid Crystal Display Techniques”, Sangyo Tosho (1996, Tokyo), Chapter 6 may be referred to.

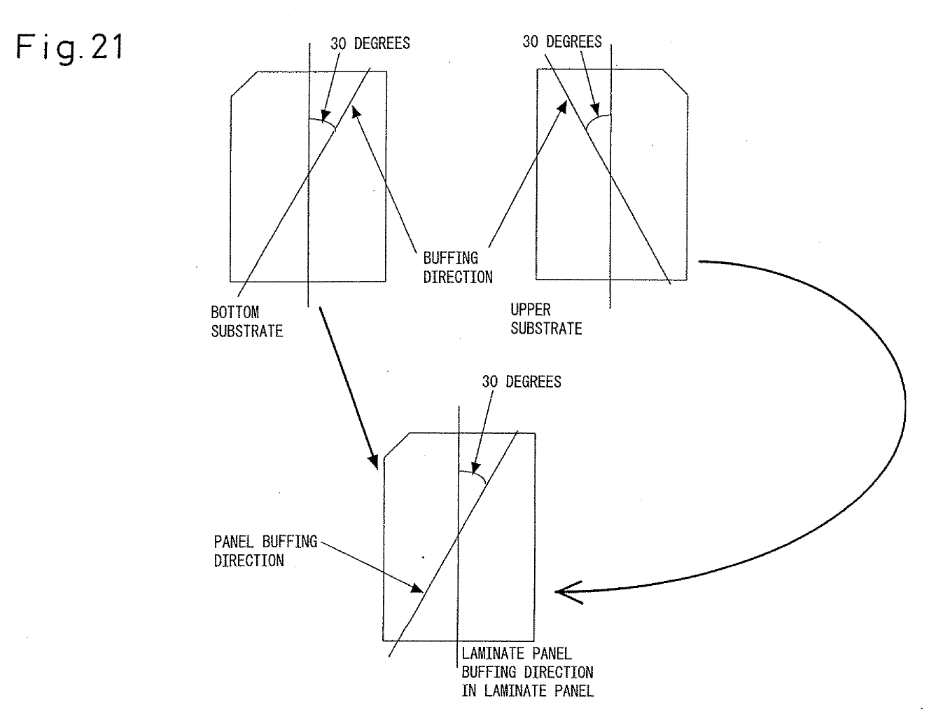

For the liquid crystal molecular alignment material, RN-1199 (Nissan Chemicals Industries) was used as 1 to 1.5° of pre-tilt angle alignment material. Thickness of the alignment layer as cured layer was set at 4,500 A to 5,000 A. The surface of this cured alignment layer was buffed by Rayon cloth (mfd. by Yoshikwa Kako, trade name 19RY) in the direction of an angle of 30 degrees to center line of the substrate shown in FIG. 21. The contact length of the buffing was set to 0.5 mm at both substrates. In FIG. 21, the angle shown in the “laminated panel” is a buffing angle for the laminated panel.

### <Buffing Conditions>

Contact length of the buffing: 0.5 mm

Number of buffing: once

Stage moving speed: 2 mm/sec.

Roller rotational frequency: 1000 rpm (R=40 mm)

Silicon dioxide balls with average diameter of 1.6 μm are used as spacer. Obtained panel gap as measured was 1.8 μm. The above mixed material was injected into the panel at the isotropic phase temperature of 110° C.

After the mixed material was injected, ambient temperature was controlled to reduce 2° C. per minute till the mixed material showed ferroelectric phase (40° C.).

Then by natural cooling, after the panel reached room temperature, the panel was applied with +/−10 V, 500 Hz of triangular waveform, 10 minutes (by use of a function generator, mfd. by NF Circuit Block Co., trade name: WF1946F). After 10 minutes voltage application, 365 nm of UV light was exposed keeping application of the same voltage (by use of a UV light, mfd. by UVP Co., trade name: UVL-56). The exposure power was set to 5,000 mJ/cm2. With respect to the details of the general industrial procedure to be used herein, as desired, a publication “Liquid Crystal Display Techniques”, Sangyo Tosho (1996, Tokyo), Chapter 6 may be referred to.

The initial molecular alignment direction of this panel was same with the buffing direction. The electro-optical measurement of this panel showed analog gray scale by application of triangular waveform voltage.

With respect to the details of the general industrial procedure to be used herein, as desired, a publication “The Optics of Thermotropic Liquid Crystals”,

Taylor and Francis: 1998, London UK; Chapter 8 and Chapter 9 may be referred to.

### Production Example 2

For the liquid crystal molecular alignment material, RN-1199 (Nissan Chemicals Industries) was used as 1 to 1.5° of pre-tilt angle alignment material. Thickness of the alignment layer as cured layer was set at 6,500 A to 7, 000 A. The surface of this cured alignment layer was buffed by Rayon cloth in the direction of 30 degrees to center line of the substrate shown in FIG. 23. The contact length of the buffing was set to 0.5 mm at both substrates. Silicon dioxide balls with average diameter of 1.6 μm are used as spacer. Obtained panel gap as measured was. 1.8 μm. In this panel, commercially available FLC mixture material (Merck: ZLI-4851-100) was injected at the isotropic phase temperature of 110° C.

After the mixed material was injected, ambient temperature was controlled to reduce 1° C. per minute till the FLC material showed ferroelectric phase (40° C.). In this slow cooling process, from Smectic A phase to Chiral Smectic C phase (75° C. to 40° C.), +/−2 V, 500 Hz of triangular waveform voltage was applied. After panel temperature reached 40° C., applied triangular waveform voltage was increased to +/−10V. Then using natural cooling, panel temperature was cooled down to room temperature with voltage application. The initial molecular alignment direction of this panel was same with the buffing direction in most of the observed area, however, in a very limited area showed +/−20 deg. shifted from the buffing angle. The electro-optical measurement of this panel showed analog gray scale switching as ×20 magnification field average at polarized microscope observation.

In this production example, it was found that too large voltage application at the slow cooling process degrades initial FLC molecular alignment. For instance, at the temperature the panel shows Smectic A phase, over +/−5V voltage is applied, there shows stripe alignment defect along with buffing direction. Once this type of defect happens, voltage application at Chiral smectic C phase (the ferroelectric liquid crystal phase) does not eliminate the defect. The voltage application at the slow cooling is effective, but its condition should be strictly controlled. In these examples showed that at Smectic A phase, up to 1 V/μm, from Smectic A phase to 10° C. below the Smectic A to Chiral 5 mC phase transition temperature, up to 1.5 V/μm, below 20° C. from the phase transition temperature, up to 5 V/μm, then lower than this temperature, up to 7.5 V/μm are preferred to obtain good result.

### Production Example 3

The liquid crystal molecular alignment material, RN-1199 (Nissan Chemicals Industries) was used as 1 to 1.5 degree of pre-tilt angle alignment material. Thickness of the alignment layer as cured layer was set at 6,500 A to 7, 000 A. The surface of this cured alignment layer was buffed by Rayon cloth in the direction of an angle of 30 degrees to center line of the substrate shown in FIG. 23. The contact length of the buffing was set to 0.6 mm at both substrates. Silicon dioxide balls with average diameter of 1.8 μm are used as spacer. Obtained panel gap as measured was 2.0 μm. In this panel, Naphthalene base FLC material described in Molecular Crystals and The liquid crystals; “Naphthalene Base Ferroelectric liquid crystal and Its Electro Optical Characteristic”; Vol. 243, pp. 77-pp. 90, (1994). was injected at the isotropic phase temperature of 130° C. This FLC material's helical pitch at room temperature was 2.5 μm.

After the material was injected, ambient temperature was controlled to reduce 1° C. per minute from 130° C. to 50° C. which shows ferroelectric phase. In this slow cooling process, from Smectic A phase to Chiral Smectic C phase (90° C. to 50° C.), +/−1 V, 500 Hz of triangular waveform voltage was applied. After panel temperature reached 50° C., applied triangular waveform voltage was increased to +/−7v.

Then using natural cooling, panel temperature was cooled down to room temperature with voltage application. The initial molecular alignment direction of this panel was same with the buffing direction in most of the view area.

Only small slight area, +/−17 deg. shifted from the buffing angle was observed. The electro-optical measurement of this panel showed analog gray scale switching as an average of the ×20 magnification field at polarized microscope observation as shown in FIG. 19. In this production example, it was also found that the applied voltage waveform during slow cooling was not limited in triangular waveform, but sine waveform, rectangular waveform were also effective to stabilize the initial molecular alignment parallel to the buffing direction.

The results obtained in the above Examples are summarized in the following Table 1.

TABLE 3
Wrap-up of Production examples

| | | | Alignment conditions | | | | | |
|---|---|---|---|---|---|---|---|---|
| | Photo- | | | Alignment | Buffing | Temperature | | |
| | sensitive | Base FLC | Pure-tilt | layer | contact | reduction | Voltage application conditions | |
| Example | material | material | (deg.) | thickness (A) | length (mm) | rate (δ/min) | Higher temperature | Lower temperature |
| Ex. 1 | Yes | ZLI-4851-100 | 1 | 5,000 | 0.5 | 2 | No | ±10 V, 500 Hz, Triangular |
| Ref. Ex. 1 | Yes | ZLI-4851-100 | 1 | 200 | 0.5 | 2 | No | ±10 V, 500 Hz, Triangular |
| Ref. Ex. 2 | Yes | ZLI-4851-100 | 1 | 5,000 | 0.1 | 2 | No | ±10 V, 500 Hz, Triangular |
| Ex. 2 | No | ZLI-4851-100 | 1 | 7,000 | 0.5 | 1 | ±2 V, 500 Hz; Triangular | ±10 V, 500 Hz, Triangular |
| Ref. Ex. 3 | Yes | ZLI-4851-100 | 1 | 5,000 | 0.5 | 5 | No | ±10 V, 500 Hz, Triangular |
| Ref. Ex. 4 | No | ZLI-4851-100 | 1 | 7,000 | 0.1 | 1 | ±2 V, 500 Hz, Triangular | ±10 V, 500 Hz, Triangular |
| Ref. Ex. 5 | No | ZLI-4851-100 | 1 | 200 | 0.1 | 1 | ±2 V, 500 Hz, Triangular | ±10 V, 500 Hz, Triangular |
| Ref. Ex. 6 | No | ZLI-1851-100 | 1 | 200 | 0.5 | 1 | ±2 V, 500 Hz, Triangular | ±10 V, 500 Hz, Triangular |
| Ref. Ex. 7 | Yes | ZLI-4851-100 | 6.5 | 5,000 | 0.5 | 2 | No | ±10 V, 500 Hz, Triangular |
| Ref. Ex. 8 | Yes | ZLI-4851-100 | 6.5 | 200 | 0.5 | 2 | No | ±10 V, 500 Hz, Triangular |
| Ref. Ex. 9 | Yes | ZLI-4851-100 | 6.5 | 5,000 | 0.1 | 2 | No | ±10 V, 500 Hz, Triangular |
| Ex. 3 | No | Naphthalene | 1 | 7,000 | 0.6 | 1 | ±1 V, 500 Hz, Triangular | ±7 V, 500 Hz, Triangular |
| Ref. Ex. 10 | No | Naphthalene | 1 | 600 | 0.2 | 1 | ±1 V, 500 Hz, Triangular | ±7 V, 500 Hz, Triangular |
| Ref. Ex. 11 | No | Naphthalene | 1 | 7,000 | 0.2 | 1 | ±1 V, 500 Hz, Triangular | ±7 V, 500 Hz, Triangular |
| Ref. Ex. 12 | No | Naphthalene | 1 | 7,000 | 0.6 | 3 | No | ±7 V, 500 Hz, Triangular |

### Example 1

As an example according to the present invention, an example of gate voltage control method is presented. A PSS-LCD panel was prepared using an amorphous silicon TFT glass substrate having 320×240 pixel elements. A glass substrate having ITO with only a patterned black mask (BM) was opposed to the substrate, and was providing a monochromatic display. The surfaces of the substrates were coated with polyimide, baked, and rubbed. Rubbing was carried out with a nylon cloth, at a contact length of 0.2 mm, a rubbing roll rotation number of 1500 rpm, and a sample feeding speed of 50 mm/sec.

A pair of opposed glass substrates were glued together, wherein a silica spacer having a particle size of 1.8 μm was used to keep a gap for the liquid crystal layer constant. A solution dissolved with the silica spacer was coated on the surface of the glass substrates. The pair of glass substrates were glued together after the solution was dried. Here, the density of the above-mentioned spacer spread on the substrates was 100 per 1 square millimeter. A two-component epoxy resin was used as an adhesive agent. The pair of glass substrates were fixed by coating and filling the adhesive agent therebetween.

A liquid crystal material for PSS-LCD (Nano Loa, Inc.) was injected to the glass substrates in a 110° C. isotropic phase to prepare a PSS-LCD panel. The optical axis azimuth of the panel was confirmed to be substantially parallel to the rubbing direction.

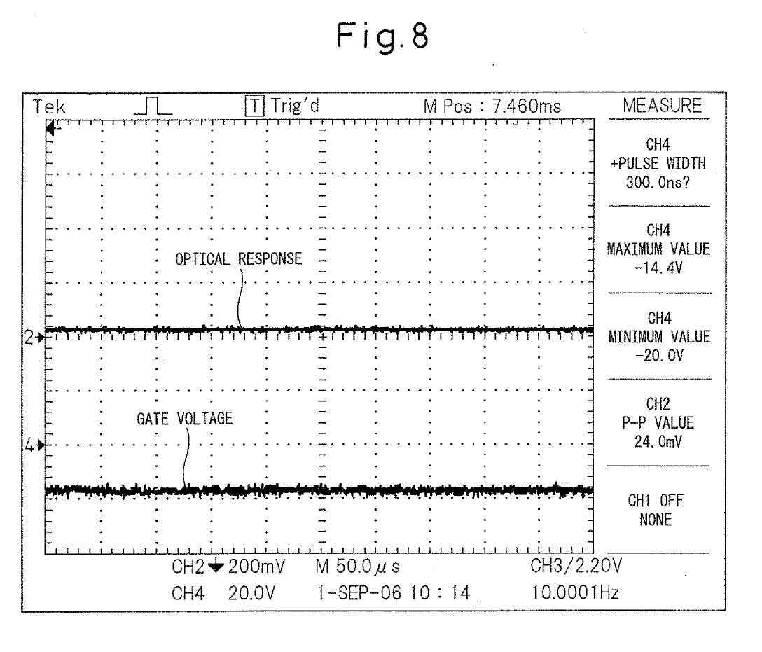

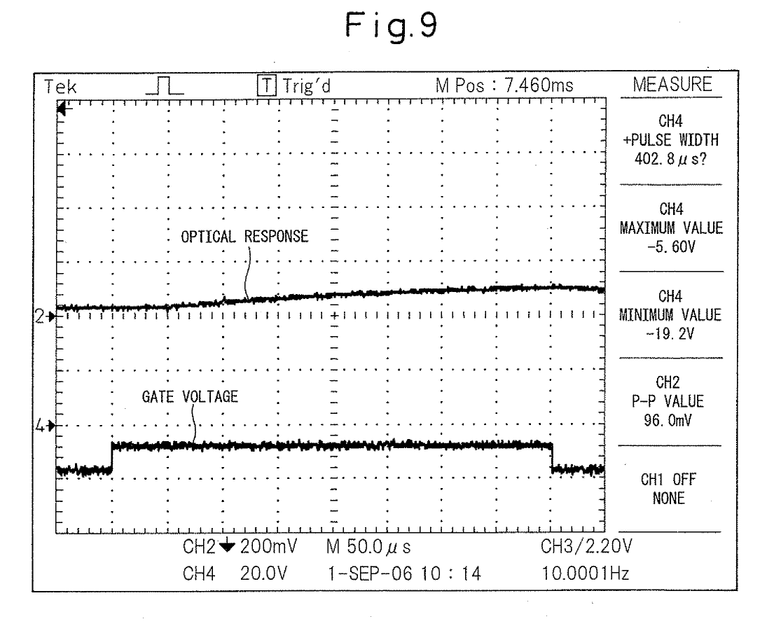

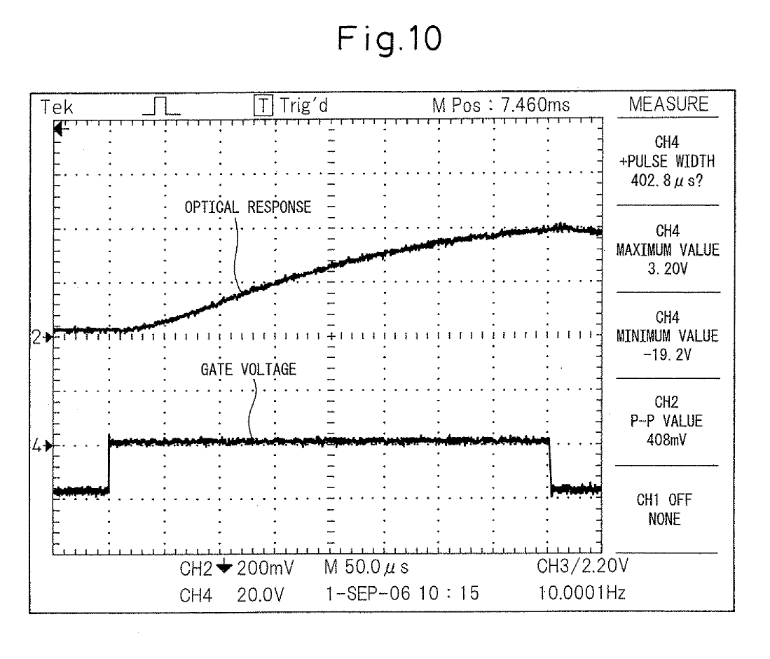

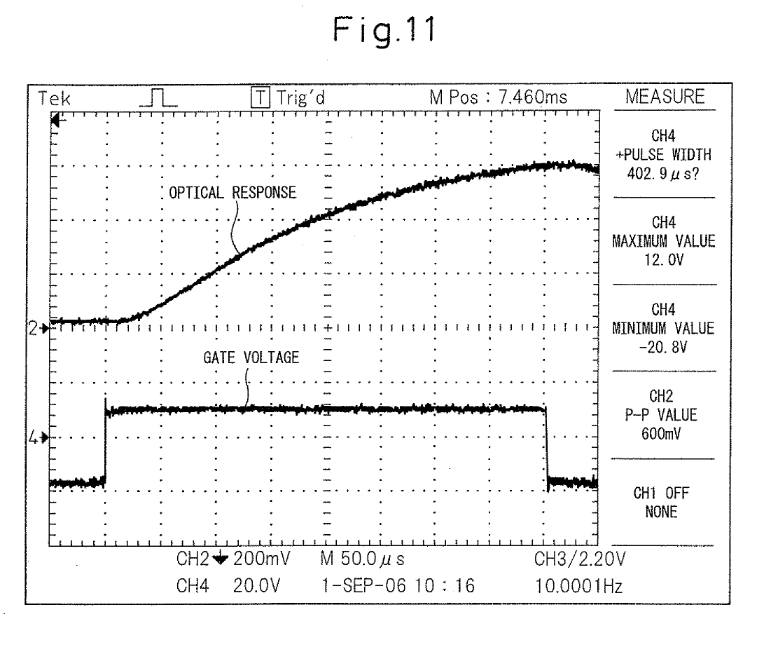

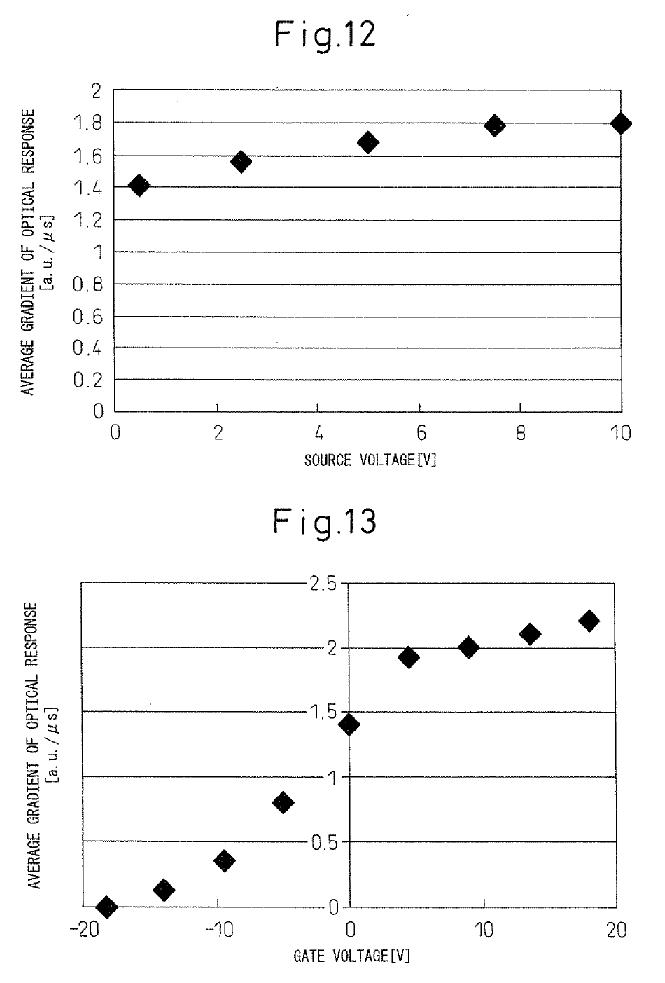

The gate-on voltage applied to the obtained PSS-LCD panel was varied from −18 V to +18 V at source voltage +5 V, gate off voltage −18 V, and gate-on time 400 μs. The charge quantity supplied to the electrode part of the liquid crystal element is changed according to the variation of gate-on voltage, therefore, the gradient representing the optical response is upward as shown in from FIGS. 8 to 11. The measurement system at this time was shown in FIG. 19. As shown in FIG. 12., the change in the gradient of the light quantity with the source voltage is quite small in the conventional source voltage controlling method. However, when the electric charge quantity to be supplied was controlled by changing the gate-on voltage shown in FIG. 13, the gradient of optical response continuously is changed, and it was confirmed that a difference in the accumulated quantity of the transmitted light was present.

### Example 2

As an example according to the present invention, an example of combination of the gate voltage control method and the source voltage control method is presented. A PSS-LCD panel was prepared using an amorphous silicon TFT glass substrate having 320×240 pixel elements. A glass substrate having ITO with only a patterned black mask (BM) was opposed to the substrate, and was providing a monochromatic display. The surfaces of the substrates were coated with polyimide, baked, and rubbed. Rubbing was carried out with a nylon cloth, at a contact length of 0.2 mm, a rubbing roll rotation number of 1500 rpm, and a sample feeding speed of 50 mm/sec.

A pair of opposed glass substrates were glued together, wherein a silica spacer having a particle size of 1.8 μm was used to keep a gap for the liquid crystal layer constant. A solution dissolved with the silica spacer was coated on the surface of the glass substrates. The pair of glass substrates were glued together after the solution was dried. Here, the density of the above-mentioned spacer spread on the substrates was 100 per 1 square millimeter. A two-component epoxy resin was used as an adhesive agent. The pair of glass substrates were fixed by coating and filling the adhesive agent therebetween.

A liquid crystal material for PSS-LCD (Nano Loa, Inc.) was injected to the glass substrates in a 110° C. isotropic phase to prepare a PSS-LCD panel. The optical axis azimuth of the panel was confirmed to be substantially parallel to the rubbing direction.

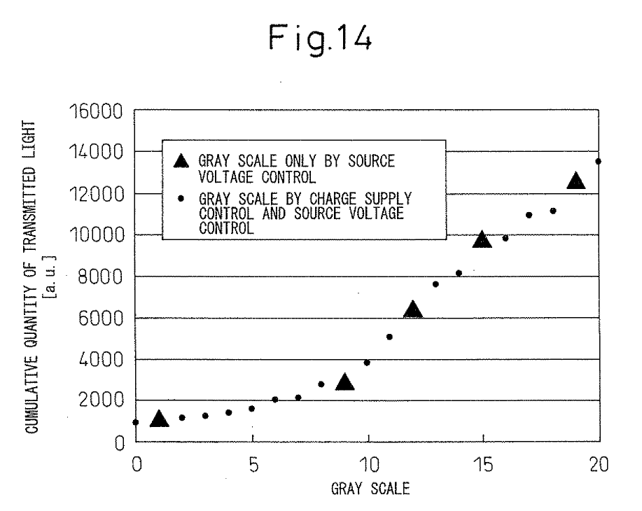

A variable signal representing the source voltage varied from 0 to +10 V, gate off voltage −18 V, gate-on time 60 μs, and the gate-on voltage varied from −18 V to +18 V was applied to the PSS-LCD panel thus obtained. A display with a further improvement of the color rendering characteristic was carried out by changing the gate-on voltage from −18 V to +18 V to control the electric charge quantity to be supplied, and controlling the source voltage. FIG. 14 shows five gradations with the source voltages of 0, 2.5, 5, 7.5, and 10 V, and intermediate gradations obtained by controlling the quantity of charge supply to supplement the five gradations by the control of the source voltage. The measurement system used is shown in FIG. 28. It was found that four time as many gradations as those in the conventional control method can be represented by combination of the two methods, and further improvement of the color rendering characteristic was confirmed.

### INDUSTRIAL APPLICABILITY

According to the present invention, as described above, there is provided a liquid crystal device, which can prevent the display quality from being reduced when the optical response speed is increased.

1. A liquid crystal device, comprising:
a liquid crystal element; the liquid crystal element comprising, at least, a pair of substrates, each of which has an electrode on the inner side thereof (on which a liquid crystal material is to be disposed), and a liquid crystal material disposed between the pair of substrates; and
a charge supplier for supplying electric charge to the liquid crystal element;
wherein the alignment of liquid crystal molecules in the liquid crystal element can be controlled on the basis of a change in the electric charge quantity to be supplied between the pair of electrodes from the charge supplier.

2. A liquid crystal device according to claim 1, wherein the liquid crystal element has an optical axis azimuth, which is rotatable in response to the intensity and/or direction of an electric field to be applied to the liquid crystal element at a level of 10 to 2 V/μm.

3. A liquid crystal device according to claim 1, wherein the liquid crystal element is capable of providing a high-speed response at a level of 1 ms.

4. A liquid crystal device according to claim 1, wherein the liquid crystal element comprises, at least, a pair of substrates and a liquid crystal material disposed between the pair of substrates, and
wherein the molecular initial alignment in the liquid crystal element is parallel or substantially parallel with the alignment treatment direction for the liquid crystal material, and the liquid crystal material shows substantially no spontaneous polarization perpendicular to the pair of substrates in the absence of an externally applied voltage.

5. A liquid crystal device according to claim 1, wherein a change in the electric charge quantity to be supplied between the pair of electrodes is dependent on at least one parameter selected from the group of time-differential value of electric field intensity, cumulative quantity of light transmitted through the liquid crystal element, voltage corresponding to each pixel element, and the gate-on time.

6. A liquid crystal device according to claim 5, wherein the voltage corresponding to each pixel element is a voltage of each TFT (thin film transistor) corresponding to each pixel element.

7. A liquid crystal device according to claim 1, wherein the charge supplier comprises, at least:
a gate voltage supplier capable of changing gate voltage in association with source voltage, so as to provide a constant potential difference between the gate voltage and source voltage;
a source voltage supplier capable of applying the source voltage, in accordance with drain voltage, which is a potential difference due to the charge stored in the previous pixel element.

8. A method of driving a liquid crystal device;
the liquid crystal device comprising: a liquid crystal element comprising, at least, a pair of substrates, each of which has an electrode on the inner side thereof, and a liquid crystal material disposed between the pair of substrates; and a charge supplier for supplying electric charge to the liquid crystal element;
wherein, the alignment of liquid crystal molecules in the liquid crystal element is controlled by changing the electric charge quantity to be supplied between the pair of electrodes from the charge supplier.

9. A driving method according to claim 8, wherein the electric charge quantity to be supplied to the liquid crystal element is controlled so as to control an increasing rate or decreasing rate, which is the time-differential value of the electric field intensity to be applied to the liquid crystal element.

10. A driving method according to claim 8, wherein the time-differential value of the electric field intensity to be applied to the liquid crystal element is controlled so as to continuously control the cumulative quantity of light transmitted through the liquid crystal element, to thereby effect a gray scale display.

11. A driving method according to claim 8, wherein the charge supplier includes TFTs, and the time-differential value of the electric field intensity is controlled by controlling the gate-on time and/or voltage for each TFT.
